(19) United States
(12) Patent Application Publication
(10) Pub. No.: US 2018/0301098 A1
(43) Pub. Date: Oct. 18, 2018

(54) DISPLAY DEVICE AND METHOD FOR DRIVING SAME

(71) Applicant: SHARP KABUSHIKI KAISHA, Sakai City, Osaka (JP)

(72) Inventor: TAKENOBU NISHIGUCHI, Sakai City (JP)

(73) Assignee: SHARP KABUSHIKI KAISHA, Sakai City, Osaka (JP)

(21) Appl. No.: 15/743,386

(22) PCT Filed: Aug. 8, 2016
(86) PCT No.: PCT/JP2016/073255

§ 371 Date: Jun. 5, 2018

(30) Foreign Application Priority Data
Aug. 18, 2015 (JP) 2015-160815

(51) Int. Cl. G09G 3/34; F21V 8/00; G02F 1/1335

(52) U.S. Cl. CPC G09G 3/3413; G02B 6/0051; G02F 2001/133342; G02F 2001/133618; G02F 1/133621

(57) ABSTRACT

A display device capable of improving luminance of a monochrome image in field sequential driving and a method for driving the same are provided. In a liquid crystal display device (100), in a case that a color image constituted by red, green, and blue colors is displayed in a first frame, in a case that a red LED (85r) emits a light only in a first field in a second frame and none of LEDs (85r, 85g, 85b) is not made to light up in second and third fields, only the red LED (85r) is made to light up in all fields in a subsequent third frame so that a red image is displayed. Therefore, in the third frame, since only the red LED (85r) emits a light in all fields, a luminance of the red image is three times a luminance of the red image in the second frame.

### TECHNICAL FIELD

The present invention relates to a display device and a method for driving the same, and particularly relates to a liquid crystal display device configured to display an image by field sequential driving and a method for driving the same.

### BACKGROUND ART

In recent years, a field sequential driving has attracted attention as one of methods for driving a liquid crystal display device configured to display a color image. In a general field sequential driving, one frame displaying one screen is divided into three fields, for which red, green, and blue Light Emitting Diodes (LEDs) as a backlight light source are sequentially switched to light up. A data voltage generated to synchronize with lighting up of each LED on the basis of image data corresponding to a color of the light is sequentially applied to a liquid crystal panel to control a transparent state of the light, and additive color mixing is performed on a retina of a viewer. This makes it possible to display a color image without forming a plurality of sub pixels in one pixel, allowing higher resolution to be achieved. The light of the LED is directly used, which eliminates the need for forming a color filter having high absorptance in each pixel. This improves light utilization efficiency of each LED.

In this way, in the field sequential driving, it is necessary to sequentially cause each of the red, green, and blue LEDs to light up for each field, and read image data corresponding to a color of the light of each LED. For this reason, in a case that a frame frequency is 60 Hz, each LED is required to light up and the image data therefor is required to be read at 180 Hz. To prevent occurrence of color breakup inherent in the field sequential driving, in a case that one frame is constituted by four or more fields, each LED need to light up and the image data therefor need to be read at high speed.

In the field sequential driving like this, even in a case where the image to be displayed is monochrome, a duration at which each of the red, green, and blue LEDs lights up is individually ensured. For example, in a case that a red image is displayed, the image is displayed only in the field for red and not displayed in the fields for green and blue. In a case that a yellow image is displayed, the image is displayed only in the fields for red and green, and not displayed in the field for blue. In any case, since the fields not displaying the image are involved, luminance of the image is disadvantageously low.

PTL 1 describes a method for suppressing a decrease in image luminance in the field sequential driving. An image display region is divided into a plurality of unit display regions, which are grouped into a plurality of groups. Each group displays monochrome images different in color from each other on the respective unit display regions for each field. In this way, the images different in color are displayed on the respective unit display regions at different times in any group to suppress the decrease in the luminance of the image to be displayed.

### CITATION LIST

### Patent Literature

PTL 1: JP 2008-268324 A

### SUMMARY OF INVENTION

### Technical Problem

The image luminance in the field sequential driving depends on a time integral of the lighting up time of the backlight light source. However, in the method disclosed in PTL 1, corresponding unit display regions in adjacent groups is only illuminated with the light of each color LED as the backlight light source at different times. For this reason, the luminance of the monochrome image displayed in this way is difficult to increase.

An object of the present invention is to provide a display device capable of improving luminance of a monochrome image in the field sequential driving and a method for driving the same.

### Solution to Problem

A first aspect of the present invention is a display device configured to separate one frame constituted by a plurality of fields into the plurality of fields and display each of images different in color for each of the plurality of fields to display a color image. The display device includes:

a display panel including a plurality of pixel forming sections arranged in a matrix;

a drive circuit configured to drive the plurality of pixel forming sections;

a backlight light source disposed on a back face side of the display panel, including a plurality of light emitting elements configured to emit lights different in color for each of the plurality of fields, and configured to illuminate the display panel with the lights emitted from the plurality of light emitting elements as a backlight;

a light source timing control unit configured to control colors of the lights emitted from the plurality of light emitting elements and timings at which the plurality of light emitting elements are made to emit the lights;

an image timing control unit configured to output a plurality of color image components representing images different in color included in input image data and a control signal which controls the drive circuit; and

a signal processor configured to separate the input image data into the plurality of color image components representing the images different in color, output the plurality of color image components to the image timing control unit for each of the plurality of fields, select a light emitting element of the plurality of light emitting elements, the light emitting element being configured to emit a light of a color required for displaying each of the plurality of color image components, and output a light emitting element control signal configured to control a light emitting timing for the light emitting element to the light source timing control unit.

The signal processor outputs the light emitting element control signal configured to cause light emitting elements of the plurality of light emitting elements to emit lights in all the plurality of fields in which the plurality of color image components representing the images different in color are outputted at one of frames, the light emitting elements being configured to emit a same color light.

According to a second aspect of the present invention, in the first aspect of the present invention, the one of frames is constituted by three fields.

The plurality of color image components include a red image components representing red image data, a green image component representing green image data, and a blue image component representing blue image data.

The backlight light source includes a red light emitting element configured to emit a red light, a green light emitting element configured to emit a green light, and a blue light emitting element configured to emit a blue light.

The signal processor is configured to output, to the light source timing control unit, a light emitting element control signal configured to cause any of the red light emitting element, the green light emitting element, and the blue light emitting element to emit a light for each of the plurality of fields in which the signal processor separates the input image data of the one of frames into the red image component, the green image component, and the blue image component and outputs the red image component, the green image component and the blue image component to the image timing control unit, and cause a same color image to be displayed in the three fields.

According to a third aspect of the present invention, in the second aspect of the present invention, the signal processor is configured to output, to the light source timing control unit, a light emitting element control signal configured to cause, in a first field in a frame immediately before a frame at which an image of a same color is displayed in the three fields, a light emitting element of a color identical to the same color in the three fields to emit a light, and cause, in second and third fields, none of the plurality of light emitting elements to emit the light.

According to a fourth aspect of the present invention, in the third aspect of the present invention, the display device further includes

a diffuser plate disposed between the display panel and the backlight light source, and configured to uniformly diffuse a backlight emitted from the backlight light source and illuminate the display panel.

An ambient light incident on a front face side of the display panel is reflected by the display panel in the second and third fields in the frame immediately before.

According to a fifth aspect of the present invention, in the first aspect of the present invention, the one of frames is constituted by three fields.

The plurality of color image components include a red image component representing red image data, a green image component representing green image data, and a blue image component representing blue image data.

The backlight light source includes a red light emitting element configured to emit a red light, a green light emitting element configured to emit a green light, and a blue light emitting element configured to emit a blue light.

The signal processor is configured to output, in a case that the input image data including a prescribed number of continuous frames not including a color image component of a specific color are detected, the red image component, the green image component, and the blue image component to the image timing control unit for each of the plurality of fields, output, to the light source timing control unit, a light emitting element control signal configured to cause two light emitting elements of the red light emitting element, the green light emitting element, and the blue light emitting element other than a light emitting element of a color corresponding to the color image component of the specific color to simultaneously emit lights for each of the plurality of fields, and cause a same color image to be displayed in the three fields.

According to a sixth aspect of the present invention, in the first aspect of the present invention, the one of frames is constituted by three fields.

The plurality of color image components include a red image component representing red image data, a green image component representing green image data, and a blue image component representing blue image data.

The backlight light source includes a red light emitting element configured to emit a red light, a green light emitting element configured to emit a green light, and a blue light emitting element configured to emit a blue light.

The signal processor is configured to output, in a case that the input image data including a prescribed number of continuous frames not including a color image component of a specific color are detected, two color image components of the red image component, the green image component, and the blue image component other than the color image component of the specific color to the image timing control unit for each of the plurality of fields, and output, to the light source timing control unit, a light emitting element control signal configured to cause two light emitting elements of the red light emitting element, the green light emitting element, and the blue light emitting element other than a light emitting element of a color corresponding to the color image component of the specific color to simultaneously light up in the three fields. The image timing control unit is configured to convert the three fields into two fields in which images corresponding to the two color image components are displayed.

The light source timing control unit is configured to cause light emitting elements of the plurality of light emitting elements of colors corresponding to the two color image components to simultaneously light up in each of the two fields and cause a same color image to be displayed in the two fields.

According to a seventh aspect of the present invention, in the fifth or sixth aspect of the present invention, the signal processor is configured to output, in a case that the input image data including a prescribed number of continuous frames constituted by all the color image components including the specific color are detected, the red image component, the green image component, and the blue image component to the image timing control unit for each of the plurality of fields, and output a light emitting element control signal configured to cause the red light emitting element, the green light emitting element, and the blue light emitting element to sequentially emit lights for each of the plurality of fields to the light source timing control unit.

According to an eighth aspect of the present invention, in the sixth aspect of the present invention, the one of frames is constituted by at least four fields. The signal processor is configured to output, in a case that the input image data including a prescribed number of continuous frames not including the color image component of the specific color are detected, two color image components of the red image component, the green image component, and the blue image component other than the color image component of the specific color to the image timing control unit for each of the plurality of fields, and output, to the light source timing control unit, a light emitting element control signal configured to cause two light emitting elements of the red light emitting element, the green light emitting element, and the blue light emitting element other than the light emitting element of a color corresponding to the color image component of the specific color to simultaneously emit lights for each of the plurality of fields.

According to a ninth aspect of the present invention, in the seventh aspect of the present invention, the plurality of color image components further include a white image component representing white image data.

The signal processor is configured to output, in a case that the input image data including a prescribed number of continuous frames not including the color image component of the specific color are detected, two color image components of the white image component, the red image component, the green image component, and the blue image component other than the white image component and the color image component of the specific color to the image timing control unit for each of the plurality of fields, and output, to the light source timing control unit, a light emitting element control signal configured to cause the two light emitting elements of the red light emitting element, the green light emitting element, and the blue light emitting element other than the light emitting element of a color corresponding to the color image component of the specific color to simultaneously emit lights for each of the plurality of fields.

According to a tenth aspect of the present invention, in the first aspect of the present invention, the one of frames is constituted by three fields.

The color image components include a red image component representing red image data, a green image component representing green image data, and a blue image component representing blue image data.

The backlight light source includes a light guide plate including a red light emitting element configured to emit a red light, a green light emitting element configured to emit a green light, and a blue light emitting element configured to emit a blue light attached to an end portion of the light guide plate.

The display device further includes a diffuser plate disposed between the display panel and the light guide plate, and configured to uniformly diffuse a backlight output from the light guide plate and illuminate the display panel

The signal processor is configured to output the light emitting element control signal to the light source timing control unit with alternately repeating frames, one of the fames being a frame at which the red image component, the green image component, and the blue image component are sequentially outputted to the image timing control unit for each of the three fields and any of the red light emitting element, the green light emitting element, and the blue light emitting element is made to emit a light in the three fields, the other of the frames being a frame at which the red image component, the green image component, and the blue image component are sequentially outputted to the image timing control unit in the three fields and none of the red light emitting element, the green light emitting element, and the blue light emitting element is made to emit lights in any of the three fields.

In the frame at which any of the red light emitting element, the green light emitting element, and the blue light emitting element is made to emit a light, the light emitted from any of the red light emitting element, the green light emitting element, and the blue light emitting element illuminates the display panel, passes through the light guide plate, and reaches the back face side.

In the frame at which none of the red light emitting element, the green light emitting element, and the blue light emitting element is made to emit lights, an ambient light incident on a front face side of the display panel is reflected by the diffuser plate, illuminates the display panel, passes through the diffuser plate and the light guide plate, and reaches the back face side.

An eleventh aspect the present invention is a method for driving a display device configured to separate one frame constituted by plurality of fields into the plurality of fields and display each of images different in color for each of the plurality of fields to display a color image. The method includes:

separating input image data into a plurality of color image components representing the images different in color;

outputting the plurality of color image components to an image timing control unit for each of the plurality of fields;

selecting a light emitting element configured to emit a light of a color required for displaying each of the plurality of color image components and outputting a light emitting element control signal configured to control a light emitting timing for the light emitting element to a light source timing control unit; and

causing a plurality of the light emitting elements configured to emit a same color light to emit lights in all the plurality of fields in one of frames at which the plurality of color image components representing the images different in color are outputted.

### Advantageous Effects of Invention

According to the first aspect of the present invention, the signal processor separates the input image data into the color image components to output each of the components to the image timing control unit for each field, and selects the light emitting element configured to emit a light of a color required for displaying the color image component to output the light emitting element control signal for controlling the light emitting timing for the light emitting element to the light source timing control unit. This causes the light emitting element configured to emit the same color of light to emit light in all the fields in one frame, improving a luminance of the monochrome image in the field sequential driving.

According to the second aspect of the present invention, only the light emitting element of any color is made to light up in the first to third fields constituting one frame. This causes the monochrome image represented in the same color to be displayed by the displayed imagery in each field, and the luminance of the image is three times the luminance of the monochrome image displayed by the normal field sequential driving.

According to the third aspect of the present invention, the light emitting element of the specific color emit a light only in the first field at the immediately before frame, and the light emitting element of the same color as the specific color is made to emit a light in all the fields at the next frame. This changes the luminance of an image of the specific color for each frame to allow a viewer to easily view the image of the specific color.

According to the fourth aspect of the present invention, none of the light emitting elements is made to emit a light in the second and third fields in a frame immediately before the frame displaying the same color image in three fields. At this time, the ambient light incident on the front face side and reflected by the diffuser plate illuminates the display panel, which allows the display panel to display a black-and-white image.

According to the fifth aspect of the present invention, in a case that a prescribed number of continuous frames not including the color image component of the specific color are detected, the color image components of respective colors are sequentially outputted to the image timing control unit for each field, and two light emitting elements of the light emitting elements of the respective colors other than the light emitting element of a color corresponding to the color image component of the specific color are made to emit tights at the same time for each field. In this way, the light emitting elements configured to emit the lights of other two colors than the specific color are made to emit lights in all the fields, which makes it possible to display the monochrome image having the luminance three times higher than that of the monochrome image displayed by the normal field sequential driving.

According to the sixth aspect of the present invention, in a case that a prescribed number of continuous frames not including the color image component of the specific color are detected, two color image components other than the color image component of the specific color are outputted to the image timing control unit for each field. The image timing control unit converts three fields into two fields to correspond to the two color image components. This makes the light emitting elements configured to emit the lights of other two colors than the specific color emit lights in all the fields at the same time, which makes it possible to display the monochrome image having the luminance three times higher than the monochrome image displayed by the normal field sequential driving.

According to the seventh aspect of the present invention, a prescribed number of continuous frames including all the color image components inclusive of the specific color are detected, the operation returns to the normal field sequential driving. In this way, in a case where a prescribed condition is met when displaying the monochrome image, the image displaying may be returned to that by the normal field sequential driving.

According to the eighth aspect of the present invention, even in a case where one frame is constituted by at least four fields, other two color image components than the image component of the specific color are outputted for each field, and the light emitting elements of a color corresponding to the two color image components are made to emit lights at the same time. In this case also, it is possible to display the monochrome image having the luminance higher than that of the monochrome image displayed by normal field sequential driving.

According to the ninth aspect of the present invention, even in a case where one frame is constituted by at least four fields and further includes the white image component, other two color image components than the white image component and the image component of the specific color are outputted for each field, and the light emitting elements of colors corresponding to the two color image components are made to emit lights at the same time. In this case also, it is possible to display the monochrome image having the luminance higher than the monochrome image displayed by normal field sequential driving.

According to the tenth aspect of the present invention, one frame is constituted by three fields, and the color image components of the respective colors are outputted for each field to alternately repeat a frame where the light emitting elements of any color of colors corresponding to the color image components of the respective colors are made to emit lights in the above three fields at the same time, and a frame where none of the light emitting elements is made to emit a light in any field. This allows the monochrome image and the image represented in black-and-white color to be alternately displayed. On the other hand, on the back face side, alternately displayed are the light of the light emitting elements output from the entire back face of the light guide plate and the black-and-white image caused by the ambient light incident on the front face side. Therefore, any viewer on the front face side or the back face side can view the image displayed to blink. Such displaying is effective when notifying the viewer of that it is dangerous, for example.

According to the eleventh aspect of the present invention, effects the same as that of the first aspect of the present invention are exerted.

### BRIEF DESCRIPTION OF DRAWINGS

FIG. 1 is a block diagram illustrating a configuration of a liquid crystal display device according to a first embodiment of the present invention.

FIG. 2 is a diagram illustrating that image data given from outside is separated into red, green, and blue LCD data by a separation circuit.

FIG. 3 is a diagram illustrating a configuration of a memory configured to store the respective separated color LCD data.

FIG. 4 is a diagram illustrating a timing chart for displaying an image by field sequential driving in the liquid crystal display device according to the above first embodiment.

FIG. 5 is a diagram illustrating a timing chart which illustrates in more detail second and third frames illustrated in the timing chart in FIG. 4.

FIGS. 6A and 6B are diagrams illustrating a transparent state of a light in a case of displaying a black character on a red background and the displayed character, and more specifically, FIG. 6A is a diagram illustrating a transparent state of a red light emitted from a backlight light source, and FIG. 6B is a diagram illustrating the character displayed on a liquid crystal panel by the red light in FIG. 6A.

FIG. 7 is a block diagram illustrating a configuration of a liquid crystal display device according to the second embodiment of the present invention.

FIG. 8 is a diagram illustrating a timing chart for displaying an image by the field sequential driving in the liquid crystal display device according to the above second embodiment.

FIG. 9 is a diagram illustrating a timing chart which illustrates in more detail second and third frames illustrated in the timing chart in FIG. 8.

FIG. 10 is a block diagram illustrating a configuration of a liquid crystal display device according to a third embodiment of the present invention.

FIG. 11 is a diagram illustrating a timing chart for displaying an image by the field sequential driving in the liquid crystal display device according to the above third embodiment.

FIG. 12 is a diagram illustrating a timing chart which illustrates in more detail second and third frames illustrated in the timing chart in FIG. 11.

FIG. 13 is a diagram illustrating a timing chart in a case that one frame is constituted by four fields to perform normal field sequential driving in a first modified example of the above third embodiment.

FIG. 14 is a diagram illustrating a timing chart in the first modified example of the above third embodiment where one frame is constituted by four fields.

FIG. 15 is a diagram illustrating a timing chart in a case that one frame is constituted by five fields to perform the normal field sequential driving in a second modified example of the above third embodiment.

FIG. 16 is a diagram illustrating a timing chart in the second modified example of the above third embodiment where one frame is constituted by five fields.

FIG. 17 is a block diagram illustrating a configuration of a liquid crystal display device according to a fourth embodiment of the present invention.

FIG. 18 is a diagram illustrating a timing chart for displaying an image by the field sequential driving in the liquid crystal display device according to the above fourth embodiment.

FIG. 19 is a diagram illustrating a timing chart which illustrates in more detail second and third frames illustrated in the timing chart in FIG. 18.

FIG. 20 is a diagram illustrating displays of four frames from the second frame to a fifth frame illustrated in FIG. 18 on a front face side and back face side of the liquid crystal display device.

### DESCRIPTION OF EMBODIMENT

### 1. First Embodiment

### 1.1 Configuration and Operation of Liquid Crystal Display Device

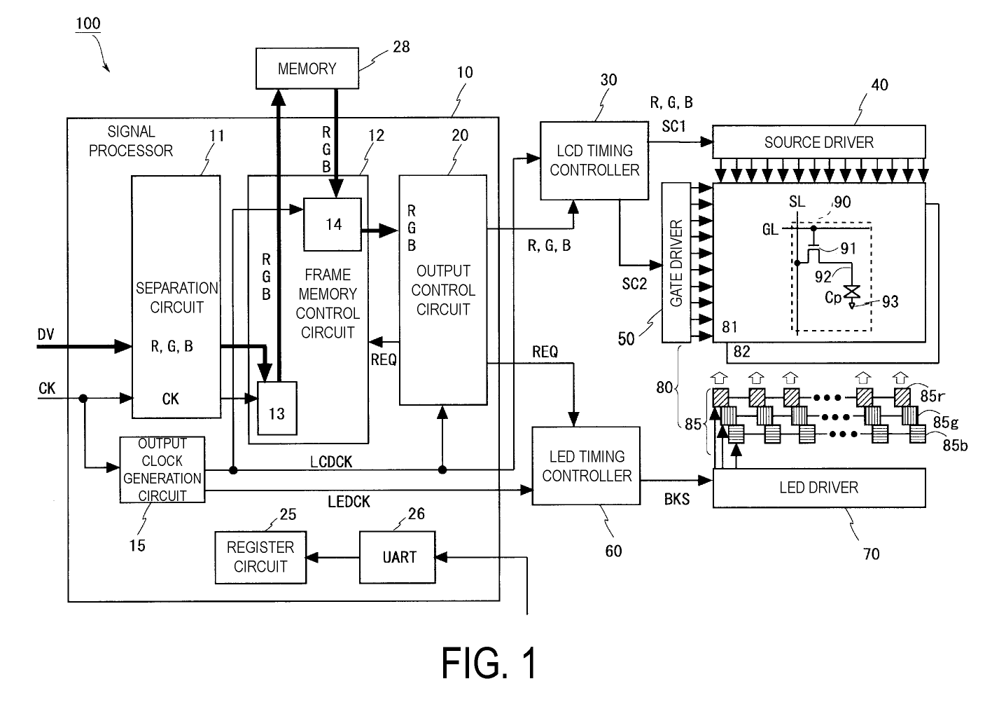

FIG. 1 is a block diagram illustrating a configuration of a liquid crystal display device 100 according to a first embodiment of the present invention. The liquid crystal display device 100 includes a signal processor 10, a memory 28, an LCD timing controller 30, an LED timing controller 60, a source driver 40 as a data signal line drive circuit, a gate driver 50 as a scanning signal line drive circuit, an LED driver 70, and a display unit 80. The display unit 80 includes a liquid crystal panel 81, and a diffuser plate 82 and a backlight light source 85 which are disposed on a back face side of the liquid crystal panel 81. Note that the liquid crystal panel 81 is described herein as a normally white type, but may be a normally black type. Note that the LCD timing controller 30 may be referred to as an image timing control unit, and the LED timing controller 60 may be referred to as a light source timing control unit. The source driver 40 and the gate driver 50 may be collectively referred to as a drive circuit.

Assume that the backlight light source 85 is a direct backlight including LEDs 85r, 85g, and 85b regularly arranged on a plane, the LEDs being configured to sequentially emit red, green, and blue lights on the liquid crystal panel 81 in a time-division manner. The diffuser plate 82 not only illuminates the liquid crystal panel 81 with the respective color of lights emitted from the backlight light source 85 but also reflects an ambient light incident from a front face side of the liquid crystal display device 100 in a case that the backlight light source 85 does not light up as described later. The ambient light illuminates the liquid crystal panel 81 similar to the backlight. Note that in the present embodiment the backlight light source 85 is described as the direct backlight including the red, green and blue LEDs 85r, 85g, and 85b arranged on a plane, but may be configured as an edge light including the red, green and blue LEDs 85r, 85g, and 85b attached to an end portion of a light guide plate. Note that the red, green and blue LEDs 85r, 85g, and 85b may be referred to as a red light emitting element, a green light emitting element, and a blue light emitting element, respectively.

The liquid crystal panel 81 includes a plurality of data signal lines SL, a plurality of scanning signal lines GL, and a plurality of pixel forming sections 90 arranged in a matrix corresponding to intersections of the plurality of data signal lines SL and the plurality of scanning signal lines GL, these being formed in the liquid crystal panel 81. FIG. 1 illustrates one pixel forming section 90, and one data signal line SL and one scanning signal line GL corresponding to the pixel forming section for the purpose of convenience. Each pixel forming section 90 includes a thin film transistor (TFT) 91 configured to operate as a switching element, the corresponding scanning signal line GL being connected with a gate terminal of the TFT 91, and the corresponding data signal line SL being connected with a source terminal of the TFT 91, a pixel electrode 92 connected with a drain terminal of the TFT 91, a common electrode 93 provided commonly to the plurality of pixel forming sections 90, and a liquid crystal layer (not illustrated) interposed between the pixel electrode 92 and the common electrode 93 and provided commonly to the plurality of pixel forming sections 90. The pixel electrode 92, the common electrode 93, and the liquid crystal layer interposed between the pixel electrode 92 and the common electrode 93 constitute a pixel capacitor Cp. A data voltage generated on the basis of an image data DV is held across the pixel capacitor Cp.

The signal processor 10 is typically implemented as an Integrated Circuit (IC), and includes a separation circuit 11, a frame memory control circuit 12, an output control circuit 20, and an output clock generation circuit 15. The frame memory control circuit 12 includes a write circuit 13 configured to write the image data DV input from the outside into the memory 28, and a read circuit 14 configured to read the image data DV from the memory 28. The signal processor 10 further includes a register circuit 25, and a Universal Asynchronous Receiver Transmitter (UART) 26 configured to mutually convert data of serial transfer type and data of parallel transfer type. The register circuit 25 provides the respective circuits in the signal processor 10 with various programs or configuration values for controlling the relevant circuits. The register circuit 25 is connected via the UART 26 with an external Personal Computer (hereinafter, referred to as a “PC”) (not illustrated), and operation of the PC allows the programs or configuration values for controlling operation of the circuits stored in the register circuit 25 to be rewritten.

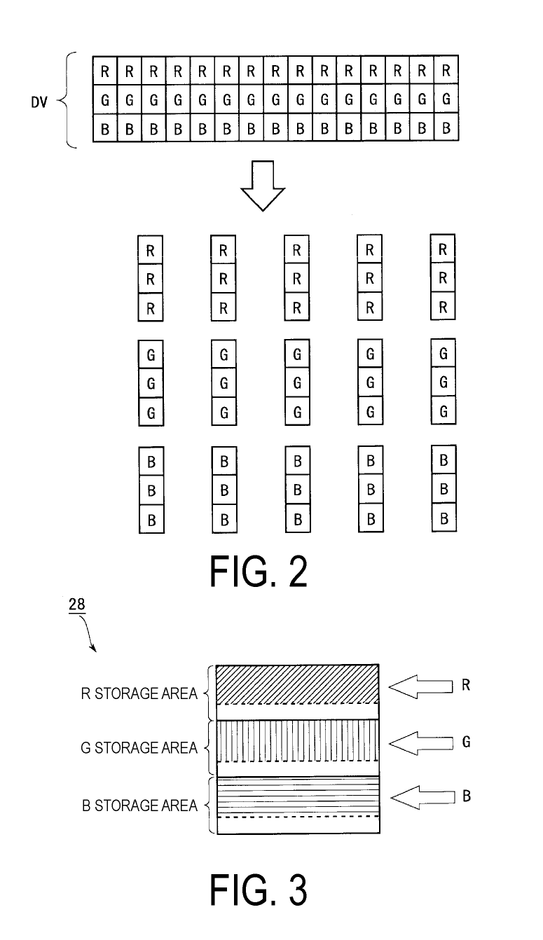

FIG. 2 is a diagram illustrating that the image data DV given from the outside is separated into red, green, and blue LCD data R, G, and B by the separation circuit 11, and FIG. 3 is a diagram illustrating a configuration of the memory 28 storing the respective separated color LCD data R, G, and B. As illustrated in FIG. 2, in a case that the image data DV is given to the separation circuit 11 of the signal processor 10, the separation circuit 11 separates the image data DV into the red LCD data R, the green LCD data G, and the blue LCD data B for each frame, and gives the data to the write circuit 13 of the frame memory control circuit 12. The write circuit 13 writes the respective color LCD data R, G, and B in a storage area configured for each color in the memory 28 on the basis of a memory clock signal (not illustrated) generated on the basis of a signal given from an external oscillation circuit (not illustrated). This causes the respective LCD data R, G, and B to be stored in a prescribed storage area in the memory 28. Note that each color LCD data may be referred to as a color image component.

Together with the image data DV, a clock signal CK given from the outside such as a vertical synchronization signal and a horizontal synchronization signal is given to the output clock generation circuit 15. The output clock generation circuit 15 generates an LCD-output clock signal LCDCK and an LED-output clock signal LEDCK on the basis of the clock signal CK, and gives the LCD-output clock signal LCDCK to the read circuit 14, the output control circuit 20 and the LCD timing controller 30, and gives the LED-output clock signal LEDCK to the LED timing controller 60.

In a case that the LCD-output clock signal LCDCK is given to the output control circuit 20, the output control circuit 20 generates a field output request signal REQ for sequentially reading the respective red, green, and blue LCD data R, G, and B from the memory 28 and gives the generated signal to the frame memory control circuit 12. In a case that the field output request signal REQ is given to the read circuit 14 in the frame memory control circuit 12, the read circuit 14 sequentially reads the respective color LCD data R, G, and B from the memory 28 at a timing depending on the memory clock signal (not illustrated) generated on the basis of the signal given from the external oscillation circuit and outputs the read data to the output control circuit 20.

The output control circuit 20 gives the respective read color LCD data R, G, and B to the LCD timing controller 30 for each frame on the basis of the LCD-output clock signal LCDCK. The LCD timing controller 30 has a function to perform required frequency conversion on the LCD data R, G, and B output for each frame, and generates a source driver control signal SC1 such as a source start pulse signal, a source clock signal, and a latch strobe signal, and a gate driver control signal SC2 such as a gate start pulse signal and a gate clock signal on the basis of the relevant LCD data R, G, and B and the LCD-output clock signal LCDCK given from the output clock generation circuit 15. Then, the LCD timing controller 30 gives the LCD data R, G, and B and the source driver control signal SC1 to the source driver 40, and gives the gate driver control signal SC2 to the gate driver 50.

The source driver 40 generates data voltages corresponding to the respective color LCD data R, G, and B on the basis of the source driver control signal SCI to apply the generated voltages to the plurality of data signal lines SL of the liquid crystal panel 81 for each field. The gate driver 50 generates a scanning signal on the basis of the gate driver control signal SC2 to apply the generated signal to the plurality of scanning signal lines GL of the liquid crystal panel 81 for each field.

The LED timing controller 60 generates a backlight control signal BKS on the basis of the field output request signal REQ given from the output control circuit 20 and the LED-output clock signal LEDCK given from the output clock generation circuit 15 to give the generated signal to the LED driver 70. The LED driver 70 causes the red, green and blue LEDs 85r, 85g, and 85b to sequentially light up on the basis of the backlight control signal BKS for each field. These LEDs constitute the backlight light source 85. Note that the backlight control signal BKS may be referred to as a light emitting element control signal.

The data voltages generated on the basis of the respective color LCD data R, G, and B are applied to each data signal line SL formed in the liquid crystal panel 81 for each field by the field sequential driving, the scanning signal is applied to each scanning signal line GL, and the lights having colors corresponding to the LCD data R, G, and B are sequentially emitted from the backlight light source 85 to the liquid crystal panel 81, which allows the viewer to view the color image displayed according to the image data DV.

### 1.2 Timing Chart

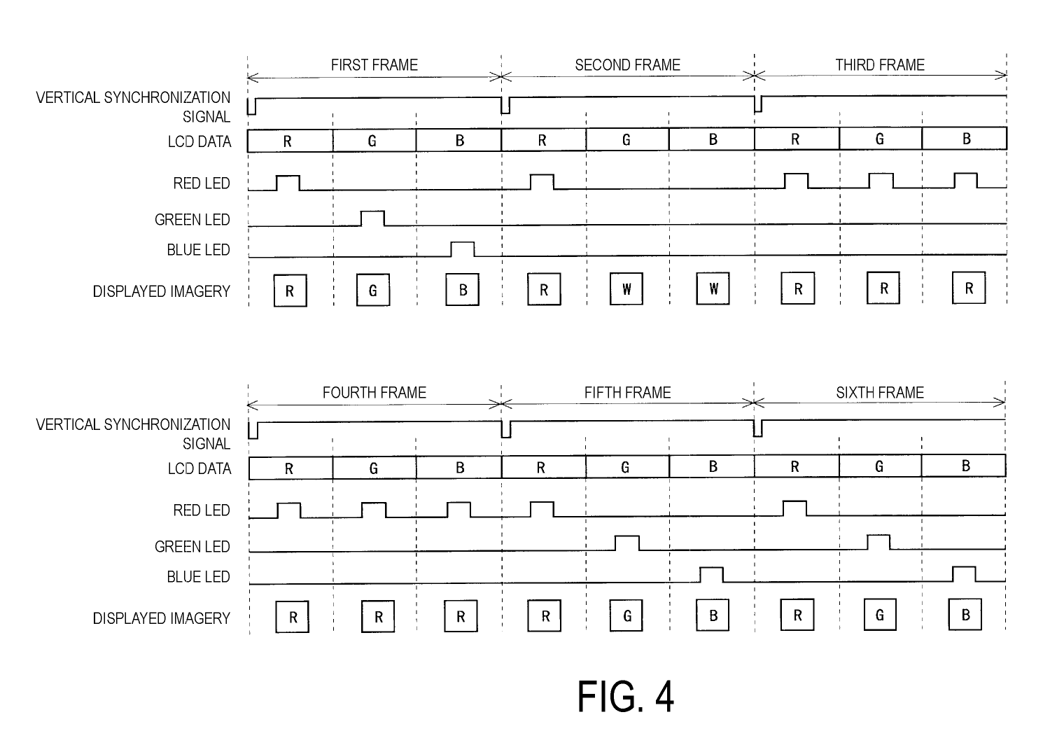

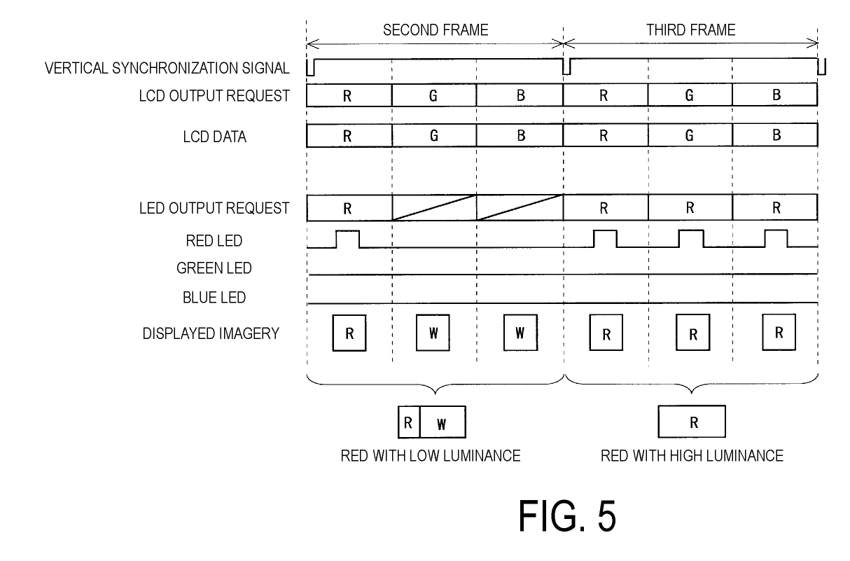

FIG. 4 is a diagram illustrating a timing chart for displaying an image by the field sequential driving in the liquid crystal display device 100 according to the present embodiment, and FIG. 5 is a diagram illustrating a timing chart which illustrates in more detail the second and third frames illustrated in the timing chart in FIG. 4.

As illustrated in FIG. 4, the field sequential driving is illustrated in which the image data DV at 60 Hz is separated into the respective red, green, and blue LCD data R, G, and B to sequentially display red, green, and blue images at 180 Hz. In FIG. 4, the read LCD data R, G, and B, the LEDs 85r, 85g, and 85b to be made to light up, and displayed images (color of a screen) are illustrated for each frame. In first, fifth and sixth frames, the respective red, green, and blue LCD data R, G, and B are sequentially read from the memory 28 for each field. The LED timing controller 60 generates the backlight control signal BKS for sequentially causing the LEDs 85r, 85g, and 85b which respectively emit the lights having the colors the same as the colors represented by the LCD data R, G, and B to light up for each field on the basis of the LED-output clock signal LEDCK given from the output clock generation circuit 15 and the field output request signal REQ given from the output control circuit 20 to give the generated signal to the LED driver 70. As a result, the red LED 85r is made to light up in a case that the red LCD data R is read, the green LED 85g is made to light up in a case that the green LCD data G is read, and the blue LED 85b is made to light up in a case that the blue LCD data B is read. This changes the displayed imagery in color to red (R), green (G), and blue (B) in this order, which allows the viewer to view the color image constituted by red, green, and blue colors.

Next, the second frame is described. As illustrated in FIG. 4 and FIG. 5, in the second frame, the field output request signal REQ for reading the respective red, green, and blue LCD data R, G, and B is given to the read circuit 14 of the frame memory control circuit 12 from the output control circuit 20 so that the respective red, green, and blue LCD data R, G, and B are read from the memory 28 for each field. On the basis of the LED-output clock signal LEDCK and the field output request signal REQ, the LED timing controller 60 generates the backlight control signal BLS for causing the red LED 85r to light up in the first field and the green and blue LEDs 85g and 85b not to light up in the second and third fields to give the generated signal to the LED driver 70.

The LED driver 70 causes the red LED 85r to light up in the first field for which the red LCD data R is read on the basis of the backlight control signal BKS, but any of the green and blue LEDs 85g and 85b not to light up in the second and third fields respectively for which the green and blue LCD data G and B are read. Therefore, in the second frame, the displayed imagery turns red and the red image is displayed in the first field, but any of the green and blue images is not displayed in the second and third fields. However, in the second and third fields, the ambient light incident on the liquid crystal panel 81 from the front face side of the liquid crystal display device 100 is reflected by the diffuser plate 82 to illuminate the liquid crystal panel 81. As a result, the displayed imagery is white (W) as illustrated in FIG. 5. At this time, in the liquid display device 81, the green or blue LCD data G or B causes the ambient light not to pass though so that a character or image represented in black color is displayed on a white background.

Next, the third frame is described. As illustrated in FIG. 4 and FIG. 5, in the third frame, the field output request signal REQ for reading the respective red, green, and blue LCD data R, G, and B is given to the read circuit 14 of the frame memory control circuit 12 from the output control circuit 20 so that the red, green, and blue LCD data R, G, and B are read for each field, similarly to the case of the second frame. However, different from the case of the second frame, the LED timing controller 60 generates the backlight control signal BKS for causing only the red LED 85r to light up not only in the first field in which the red LCD data R is given but also in the second and third fields in which the green and blue LCD data. G and B are given, respectively, to give the generated signal to the LED driver 70. In other words, the red, green, and blue LCD data R, G, and B are sequentially read for each field, but only the red LED 85r is made to light up in each of the first to third fields. This causes any displayed imagery in the respective fields to turn red to display only the red image. The same applies to the case of the fourth frame, in which only the red image is displayed.

In other words, since, in the above second frame, the green LED 85g is not made to light up in the second field where a green image is to be displayed, and the blue LED 85b is not made to light up in the third field where a blue image is to be displayed, the red image and the white image are displayed. However, the data voltage generated on the basis of the green LCD data G is applied to the data signal line SL in the second field in the above third frame, the data voltage generated on the basis of the blue LCD data B is applied to the data signal line SL in the third field, and further, only the red LED 85r is made to light up in the second and third fields. As a result, in the third frame, a duration at which the red LED 85r lights up is three times as compared to a normal case, and thus, luminance of the red image is nearly tripled, making only the red image to be displayed more emphatically. The same applies to the case of the fourth frame, in which only the red image is emphatically displayed.

In this way, the red image having the low luminance is displayed in the second frame and the red image having the higher luminance than that in the second frame is displayed in the third and fourth frames, allowing the red monochrome image to be further emphasized as compared with a case that the second frame is not provided.

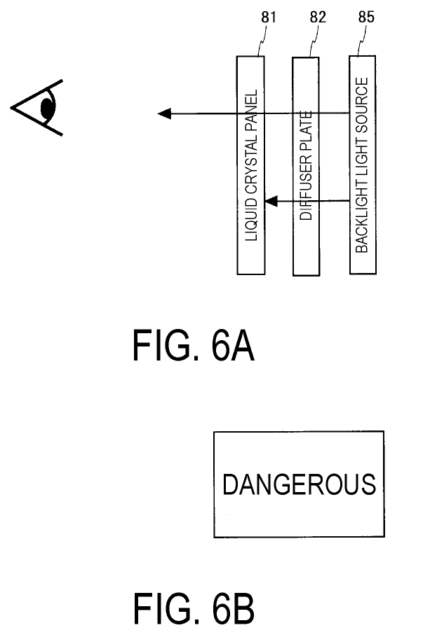

FIGS. 6A and 6B are diagrams illustrating the transparent state of the light in a case that a black character is displayed on a red background and the displayed character, and more specifically, FIG. 6A is a diagram illustrating the transparent state of a red light emitted from the backlight light source 85, and FIG. 6B is a diagram illustrating the character displayed on the liquid crystal panel 81 by the red light in FIG 6A. As illustrated in FIG. 6A, the red light emitted from the backlight light source 85 is diffused uniformly through the diffuser plate 82 and then illuminates the liquid crystal panel 81. In the liquid crystal panel 81, an orientation of liquid crystal molecules is controlled for each pixel forming section by the data voltage depending on the LCD data so that the red light passes through the liquid crystal panel 81 or blocked. As a result, as illustrated in FIG. 6B, an area through which the red light passes turns red and an area which blocks the red light is displayed in black color, and black characters “dangerous” are displayed on the red background. Here, a program is written in the register circuit 25 from the PC via the UART 26, the program being for inserting a frame displaying a simple word such as the characters “dangerous” in black color on the red background in a case that, for example, an emergency early warning about the weather and the like is issued. This allows the output control circuit 20 to interrupt displaying the content and insert a frame displaying the characters “dangerous” in black color on the red background as in the above second to fourth frames. As a result, the viewer can easily recognize that it is “dangerous”. Note that not only interrupting displaying the content to insert such an image but also the image data like this may be included in the content in advance.

Moreover, the red image having the high luminance may be displayed by displaying the color image in the second frame similar to the case of the first frame and causing the red LED 85r to light up in the first to third fields in the third and fourth frames.

Note that, in the above embodiment, only the red LED 85r is made to light up in the fields constituting one frame so that the red monochrome image is displayed. However, instead of the red LED 85r, only the green LED 85g may be made to light up so that a green monochrome image is displayed or only the blue LED 85b may be made to light up so that a blue monochrome image is displayed for each field.

### 1.3 Effects

According to the present embodiment, only the red LED 85r is made to light up in the first to third fields constituting one frame as in the third and fourth frames so that all the displayed images in each the fields turn red and the red monochrome image can be displayed at the luminance three times that of a case of the normal field sequential driving.

In addition, the red monochrome image is displayed in the first field in the second frame, and next, the red monochrome image having the high luminance is displayed in the first to third fields in the third and fourth frames. This makes the luminance of the monochrome image change, allowing the viewer to more easily view the red monochrome image,

The program for notifying the viewers of that it is “dangerous” is written in the register circuit 25 from the external PC while the image is displayed, in a case where an emergency early warning is issued. This makes it possible to insert a frame notifying the viewers of a simple word or image such as the characters “dangerous” in black color on the red background, allowing the viewer's attention to be invited.

### 2. Second Embodiment

### 2.1 Configuration and Operation of Liquid Crystal Display Device

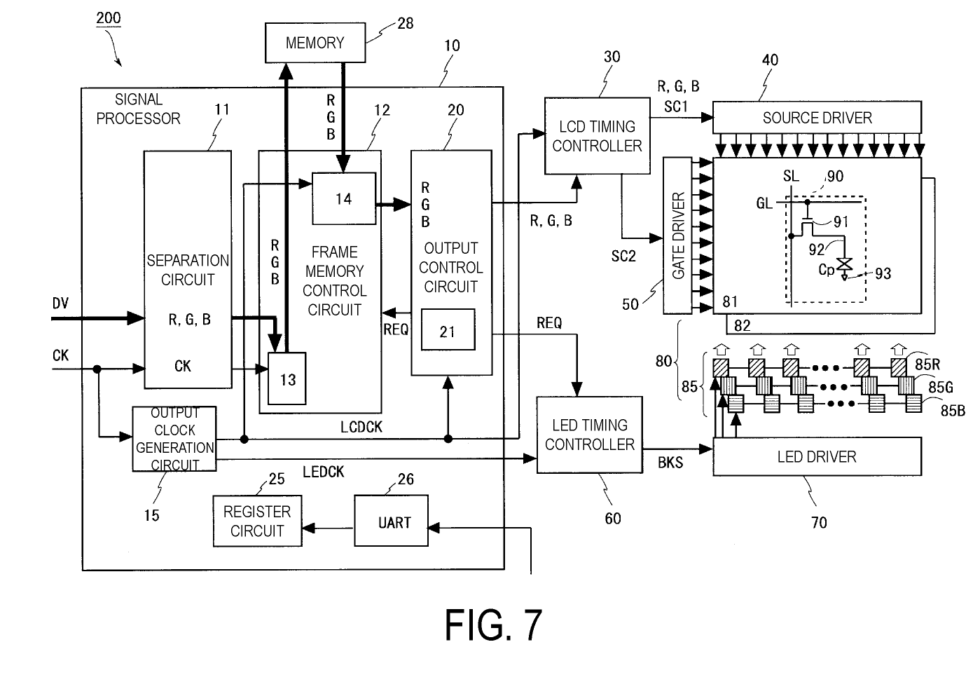

FIG. 7 is a block diagram illustrating a configuration of a liquid crystal display device 200 according to a second embodiment of the present invention. The liquid crystal display device 200 has a configuration similar to the liquid crystal display device 100 illustrated in FIG. 1 according to the first embodiment, but is different in that an image detection circuit 21 is provided in the output control circuit 20 of the signal processor 10. Therefore, the same components as in the liquid crystal display device TOO illustrated in FIG. 1 are denoted by the same reference signs, and the descriptions thereof are omitted and different components are described.

The image detection circuit 21 detects a frame at which the blue LCD data B is “0” and counts the number of the detected frames. In a case that the number of the frames becomes the same value as a configuration value, the LCD timing controller 30 sequentially reads the respective red, green, and blue LCD data R, G, and B from the memory 28 for the first to third fields of the frames starting from next frame to a prescribed frame, and the LED timing controller 60 causes the red LED 85r and the green LED 85g to light up at the same time. According to this operation, in the frame where the red LED 85r and the green LED 85g light up at the same time, a yellow monochrome image is displayed where red and green are mixed. Note that in the present embodiment, blue with the LCD data B of “0” may be referred to a specific color.

The image detection circuit 21, after the red LED 85r and the green LED 85g light up at the same time so that the yellow monochrome image is displayed, detects a frame having the LCD data R, G, and B none of which is “0” and counts the number of the detected frames. In a case that the number of the frames becomes the same value as a configuration value, the LCD timing controller 30 sequentially reads the respective red, green, and blue LCD data R, G, and B from the memory 28 for the first to third fields, and the LED timing controller 60 enters into the normal field sequential driving in which the red, green and blue LEDs 85r, 85g, and 85b sequentially light up. This displays the color image constituted by red, green, and blue colors.

### 2.2 Timing chart

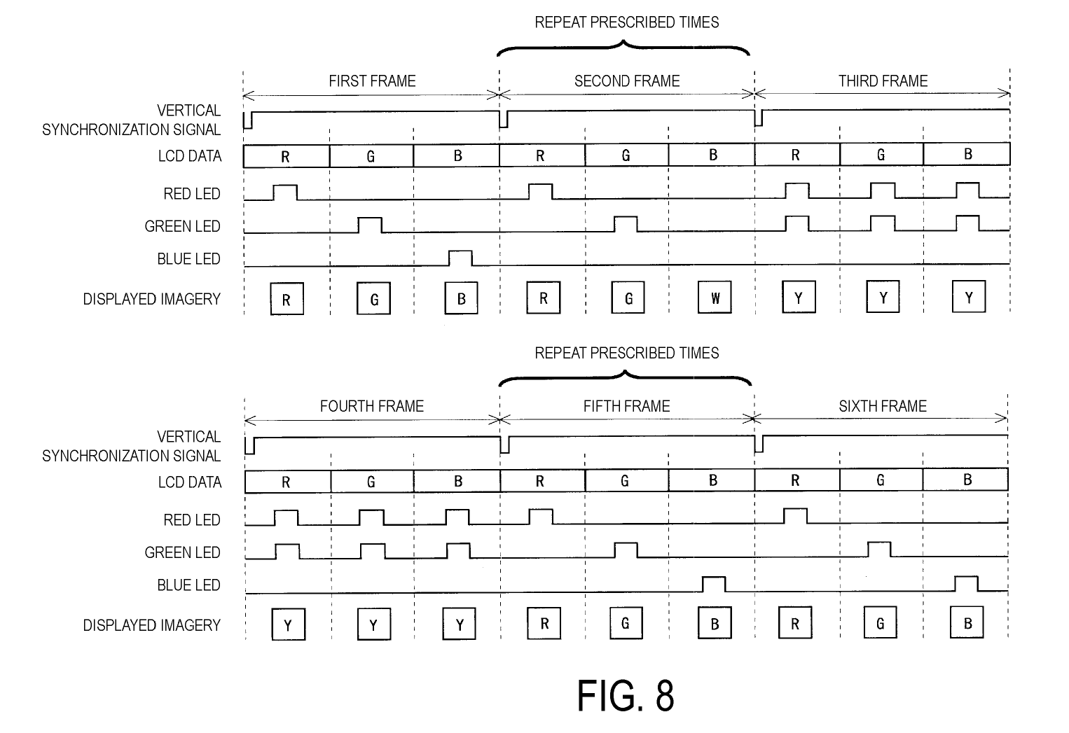

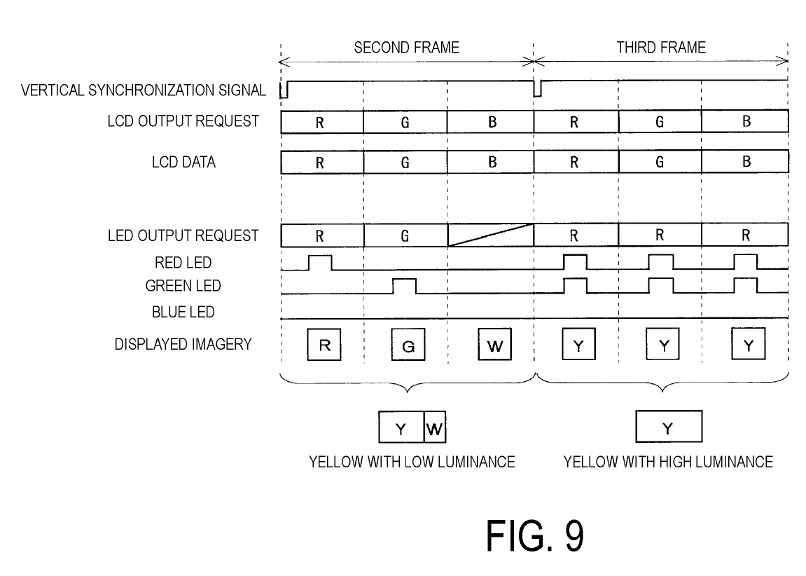

FIG. 8 is a diagram illustrating a timing chart for displaying an image by the field sequential driving in the liquid crystal display device 200 according to the present embodiment, and FIG. 9 is a diagram illustrating a timing chart which illustrates in more detail second and third frames illustrated in the timing chart in FIG. 8.

FIG. 8 illustrates the field sequential driving in which the image data DV at 60 Hz is separated into the respective red, green, and blue LCD data R, G, and B to sequentially display the red, green, and blue images at 180 Hz in a time-division manner, similar to the case illustrated in FIG. 4. In the first and sixth frames, the red LED 85r is made to light up in a case that the red LCD data R is read, the green LED 85g is made to light up in a case that the green LCD data G is read, and the blue LED 85b is made to light up in a case that the blue LCD data B is read, similar to the case of the first frame illustrated in FIG. 4. This changes the displayed imagery in color to red, green, and blue in this order, which allows the viewer to view the color image constituted by red, green, and blue colors.

Next, the second frame is described. As illustrated in FIG. 8 and FIG. 9, in the second frame, the output control circuit 20 gives the field output request signal REQ for reading the respective red, green, and blue LCD data R, G, and B to the read circuit 14 of the frame memory control circuit 12. In response to this operation, the respective red, green, and blue LCD data R, G, and B are sequentially read from the memory 28 for each field. At this time, in a case that the image detection circuit 21 detects that the blue LCD data B is “0”, the output control circuit 20 gives to the LCD timing controller 30 the LCD data R and G as well as notifies the LCD timing controller 30 of that the LCD data B is “0”. The LED timing controller 60 causes the red LED 85r to light up in the first field for which the red LCD data R is read, and the green LED 85g to light up in the second field for which the green LCD data G is read on the basis of the LED-output clock signal LEDCK given from the output clock generation circuit 15 and the field output request signal REQ given from the output control circuit 20. However, because the blue LCD data B is “0”, the blue LED 85b is not made to light up in the third field. In this way, in the second frame, the red LED 85r and the green LED 85g sequentially are made to light up in the first and second fields, and none of the LEDs 85r, 85g, and 85b is made to light up in the third field. For this reason, in the third field, the ambient light incident from the front face side is reflected by the diffuser plate 82 and illuminates the liquid crystal panel 81. As a result, the displayed imagery turns white. In this way, the displayed imagery changes in color to red, green, and white in this order, which allows the viewer to view the yellow monochrome image constituted by red and green colors.

Note that in FIG. 9, even in a case where there is at least one frame at which the blue LCD data B is “0”, the transition from the second frame to the third frame may occur. However, the image detection circuit 21 may count the number of frames at which the blue LCD data B is “0”, and in a case that the number of the counted frames becomes the same value as a configuration value, the transition from the second frame to the third frame may occur.

In the third frame, as illustrated in FIG. 8 and FIG. 9, the output control circuit 20 gives the field output request signal REQ for reading the respective red, green, and blue LCD data R, G, and B to the read circuit 14 of the frame memory control circuit 12. In response to this operation, the respective red, green, and blue LCD data R, G, and B are sequentially read from the memory 28 for each field, and given to the LCD timing controller 30. The LED timing controller 60 causes the red LED 85r and the green LED 85g to light up at the same time in all of the first field in which the red LCD data R is given, the second field in which the green LCD data G is given, and the third field in which the blue LCD data B is given on the basis of the LED-output clock signal LEDCK given from the output clock generation circuit 15. In other words, in the first to third fields, the red, green, and blue LCD data R, G, and B are sequentially read for each field, but the red LED 85r and the green LED 85g light up at the same time in each field. The same is applied to the fourth frame.

In this way, in the second frame of the content constituted by color images, in a case where a frame at which the blue LCD data B is “0” is detected, only the red LED 85r is made to light up in the first field in the second frame, and the green LED 85g is made to light up in the second field, but the blue LED 85b is not made to light up in the third field. This causes the displayed imagery in each field to turn yellow (Y) so that the yellow monochrome image is displayed. Further, in the third frame, in the first to third fields, the LCD timing controller 30 sequentially applies the data voltages generated from the respective color LCD data R, G, and B to the data signal lines SL, and the LED timing controller 60 controls the LED driver 70 so that the red and green LEDs 85r and 85g light up at the same time. This allows the yellow monochrome image to be displayed in the third frame, the luminance of which is about three times that of the case of the second frame. At this time, the blue LCD data B may not be “0”.

The same applies to the fourth frame, in which the yellow monochrome image having the high luminance is displayed, and the transition to the fifth frame is made. In the fifth frame, the image detection circuit 21 counts the number of frames having the LCD data R, G, and B none of which is “0”, and in a case that the number of the counted frames becomes the same value as a configuration value, transition from the fifth frame to the sixth frame occurs. In the sixth frame, the red, green and blue LEDs 85r, 85g, and 85b sequentially light up for each field. This allows the displayed imagery in color to change to red, green, and blue in this order, which allows the viewer to view the color image constituted by red, green, and blue colors.

In FIG. 8, even in a case where there is at least one frame having the LCD data R, G, and B none of which is “0” in the fifth frame, the transition to the sixth frame is made. However, the transition from the fifth frame to the sixth frame may occur in a case that the number of frames having the LCD data R, G, and B none of which is “0” becomes three, for example. In this case, after the number of frames at which none of the LCD data R, G, and B is “0” becomes two, in a case where a frame at which the blue LCD data B is “0” is detected, transition occur from the fifth frame to a frame where the yellow monochrome image having the high luminance is displayed, such as the third frame.

Note that the number of frames at which the blue LCD data B is “0” and which are required for the transition from the second frame to the third frame, the number of frames at which the yellow monochrome image having the high luminance is displayed and which are required for the transition from the fourth frame to the fifth frame, and the number of frames required for the transition from the fifth frame to the sixth frame are configured in the output control circuit 20 and can be changed using the register circuit 25 as needed.

In FIG. 8, first, the yellow image having a low luminance is displayed in the second frame, and next, the yellow image having a high luminance is displayed in the third and fourth frames, which changes the luminance of the yellow monochrome image in a stepwise fashion as compared with the case of no such second frame provided. This allows the viewer to more easily view the yellow monochrome image.

Similar to the case of the first embodiment, the liquid crystal molecules alignment is controlled using the data voltage applied to the liquid crystal layer to allow the lights from the red and green LEDs 85r and 85g to pass through to display a yellow color or be blocked to display a black color. For this reason, a black character can be displayed on a yellow background, for example.

In the present embodiment, the description is made referring to the case that only the red LED 85r and green LED 85g are made to light up so that the yellow monochrome image is displayed as an example. However, the present embodiment may be similarly applied to a case that only the green LED 85g and blue LED 85b are made to light up so that a cyan monochrome image is displayed, or only the red LED 85r and blue LED 85b are made to light up so that a magenta monochrome image is displayed.

### 2.3 Effects

According to the present embodiment, in the first to third fields constituting one frame as in the fourth and fifth frames, the red LED 85r and green LED 85g are made to light up at the same time. This causes all the displayed imagery in respective fields to turn yellow, which allows the yellow monochrome image to be displayed at the luminance three times that of the case of displaying imagery by the normal field sequential driving.

In addition, the yellow monochrome image is displayed in the first field in the second frame, and next, the yellow monochrome image having the high luminance is displayed in the first to third fields in the third and fourth frames, allowing the viewer to more easily view the yellow monochrome image.

### 3. Third Embodiment

### 3.1 Configuration and Operation of Liquid Crystal Display Device

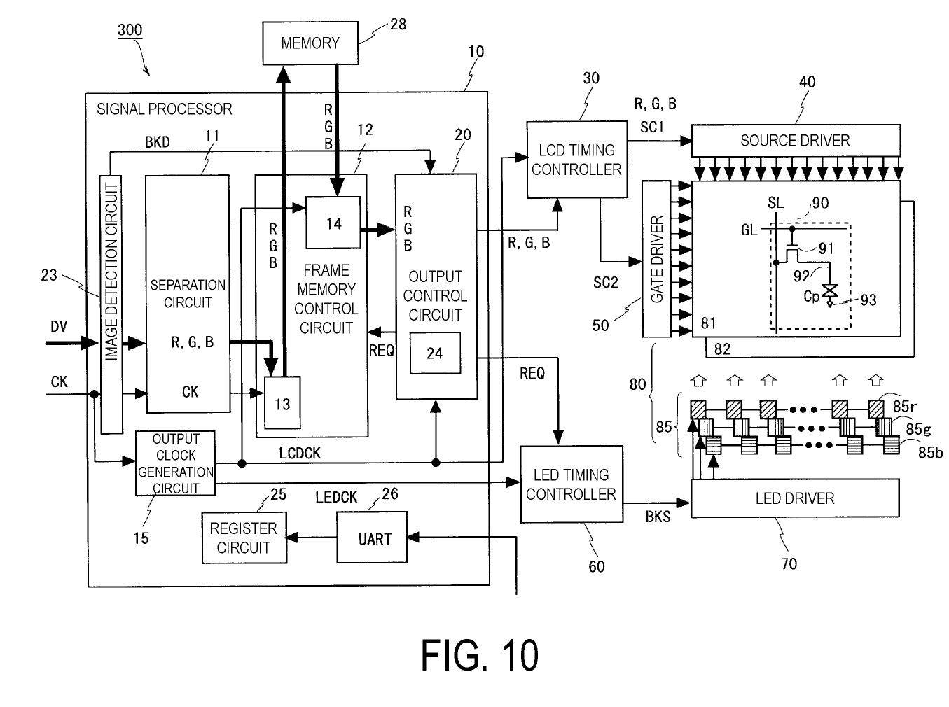

FIG. 10 is a block diagram illustrating a configuration of a liquid crystal display device 300 according to a third embodiment of the present invention. The liquid crystal display device 300 has a configuration similar to the liquid crystal display device 200 according to the second embodiment illustrated in FIG. 7. However, a difference is that besides the image detection circuit provided in the output control circuit 20 of the signal processor 10, an image detection circuit is further provided also to a stage prior to the separation circuit 11. Therefore, the image detection circuit provided to the stage prior to the separation circuit 11 is referred to as a first image detection circuit 23, and the image detection circuit provided in the output control circuit 20 is referred to as a second image detection circuit 24. The same components as in the liquid crystal display device 200 illustrated in FIG. 7 are denoted by the same reference signs, and the descriptions thereof are omitted and different components are described.

The liquid crystal display device 300 according to the present embodiment is provided with the first image detection circuit 23 configured to detect the blue LCD data B from the image data DV input from the outside at the stage prior to the separation circuit 11. Therefore, the image data DV input from the outside is input first to the first image detection circuit 23. In a case where the first image detection circuit 23 does not detect the blue LCD data B from the image data DV (in a case where B is “0”), the first image detection circuit 23 outputs backlight data BKD to the output control circuit 20 and gives the image data DV to the separation circuit 11. In a case where the first image detection circuit 23 detects the blue LCD data B which is not “0” from the image data DV, the first image detection circuit 23 gives the image data DV to the separation circuit 11 without outputting the backlight data BKD. The separation circuit 11, as described in the first embodiment, separates all the image data DV into the red, green, and blue LCD data R, G, and B regardless of whether blue LCD data B is “0” and stores the separated data in the memory 28. Not that in the present embodiment, blue with the LCD data B of “0” is referred to as specific color.

In a case that the backlight data BKD is given from the first image detection circuit 23 to the output control circuit 20, the output control circuit 20 gives the field output request signal REQ to the read circuit 14 in order to read the red and green LCD data R and G from the memory 28. In response to this operation, the red and green LCD data R and G are read from the memory 28 to the output control circuit 20, and the output control circuit 20 gives the read data to the LCD timing controller 30. The LCD timing controller 30 performs the frequency conversion on the basis of the red and green LCD data R and G given from the output control circuit 20 to configure one frame constituted by two fields. Further, the LCD timing controller 30 generates the source driver control signal SCI and the gate driver control signal SC2 on the basis of the LCD-output clock signal LCDCK given from the output clock generation circuit 15 to output the generated signals SC1 and SC2 to the source driver 40 and the gate driver 50, respectively. The LED timing controller 60 generates the backlight control signal BKS for causing the red and green LEDs 85r and 85g to light up at the same time in the two fields on the basis of the field output request signal REQ given from the output control circuit 20 and the LED-output clock signal LEDCK given from the output clock generation circuit 15 to output the generated signal to the LED driver 70.

This makes the red LED 85r and the green LED 85g emit the lights at the same time in the first field to which the data voltage generated on the basis of the red LCD data R is applied and in the second field to which the data voltage generated on the basis of the green LCD data G is applied, allowing the displayed imagery to turn yellow in both fields so that the yellow monochrome image is displayed.

On the other hand, in a case that the backlight data BKD is not given from the first image detection circuit 23, the output control circuit 20 gives the field output request signal REQ to the read circuit 14 in order to read the red, green and blue LCD data R, G, and B from the memory 28. In response to this operation, the respective red, green, and blue LCD data R, G, and B are read from the memory 28 to the output control circuit 20 so that a color image constituted by red, green, and blue colors is displayed, similar to the case of the first frame in the second embodiment.

Note that the second image detection circuit 24 provided in the output control circuit 20 counts the number of frames in which none of the LCD data R, G, and B, read from the memory 28 for each frame, is “0”, and in a case that a count value becomes a configuration value, the LED timing controller 60 performs transition to the sixth frame in which the red, green and blue LEDs 85r, 85g, and 85b are made to sequentially emit the lights in a time-division manner.

### 3.2 Timing chart

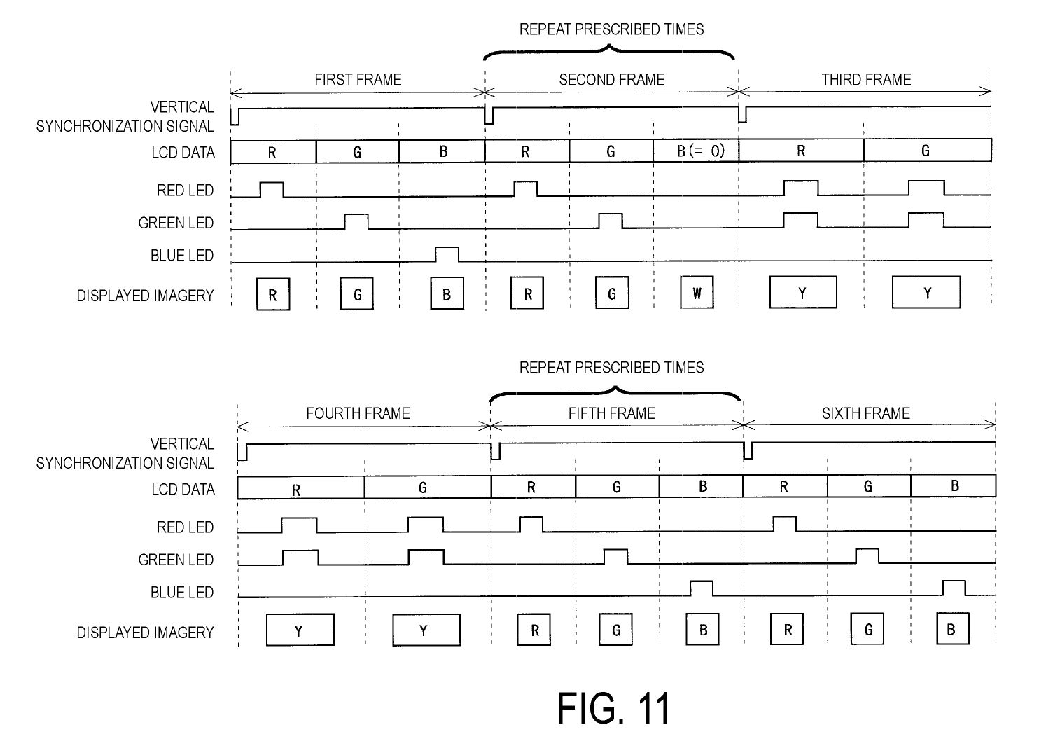

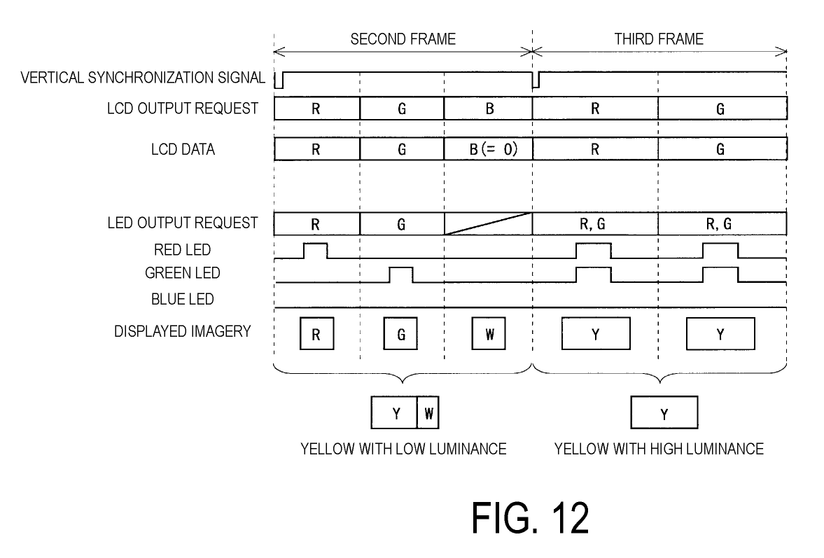

FIG. 11 is a diagram illustrating a timing chart for displaying an image by the field sequential driving in the liquid crystal display device 300 according to the present embodiment, and FIG. 12 is a diagram illustrating a timing chart which illustrates in more detail second and third frames illustrated in the timing chart in FIG. 11.

FIG. 11 illustrates the field sequential driving in which the image data at 60 Hz is separated into the respective red, green, and blue LCD data. R, G, and B to sequentially display red, green, and blue images at 180 Hz, similar to the case illustrated in FIG. 8. In the first and sixth frames, the red LED 85r is made to light up in a case that the red LCD data R is read, the green LED 85g is made to light up in a case that the green LCD data G is read, and the blue LED 85b is made to light up in a case that the blue LCD data B is read, similar to the case of the first frame illustrated in FIG. 8. Therefore, the displayed imagery changes to red, green, and blue in this order for each field, which allows the viewer to view the color image constituted by red, green, and blue colors.

Next, the second frame is described. As illustrated in FIG. 11 and FIG. 12, since the blue LCD data B is “0” in the second frame, the first image detection circuit 23 detects the blue LCD data B of “0” in the image data and outputs the backlight data BKD to the output control circuit 20. The image data DV configuring the second frame is separated by the separation circuit 11 into the red, green, and blue LCD data R, G, and B and stored in the memory 28. The output control circuit 20 gives the field output request signal REQ to the read circuit 14 in order to read the red and green LCD data R and G, on the basis of the backlight data BKD given from the first image detection circuit 23. In response to this operation, the respective red and green LCD data R and G are sequentially read from the memory 28. At this time, since the blue LCD data B is “0”, the output control circuit 20 gives the LCD timing controller 30 the LCD data R and G as well as notifies the LCD timing controller 30 of that the LCD data B is “0”. The LED timing controller 60 generates the backlight control signal BKS for causing the red LED 85r to light up in the first field for which the red LCD data R is read and the green LED 85g to light up in the second field for which the green LCD data G is read on the basis of the LED-output clock signal LEDCK given from the output clock generation circuit 15 and the field output request signal REQ given from the output control circuit 20 to output the generated signal to the LED driver 70. However, because the blue LCD data B is “0”, the blue LED 85b is not made to light up in the third field. In this way, in the second frame, since the red LED 85r and the green LED 85g sequentially light up in the first and second fields and the blue LED 85b does not light up in the third frame, the displayed imagery changes in color to red, green, and white in this order along the fields. As a result, the yellow monochrome image is displayed, but the luminance thereof is low as compared with a case of the third frame described later.

Note that in FIG. 11, even in a case where there is at least one frame at which the blue LCD data B is “0”, transition from the second frame to the third frame described later occur. However, the second image detection circuit 24 may count the number of frames at which the blue LCD data B is “0”, and in a case that the count number becomes the same value as a configuration value, the transition from the second frame to the third frame may occur.

In the third frame, as illustrated in FIG. 11 and FIG. 12, the output control circuit 20 generates the field output request signal REQ for reading the red and green LCD data R and G to give the generated signal to the read circuit 14. In response to this operation, the respective red and green LCD data R and G are read from the memory 28. The output control circuit 20 gives the red and green LCD data R and G to the LCD timing controller 30. At this time, the second image detection circuit 24 notifies the LCD timing controller 30 of that the blue LCD data B is “0”. The LCD timing controller 30 performs the frequency conversion to configure one frame constituted by two fields, and outputs the red LCD data R to the source driver 40 in the first field and the green LCD data G to the source driver 40 in the second field. The LED timing controller 60 generates the backlight control signal BKS for causing the red LED 85r and the green LED 85g to light up at the same time in the first field and the second field on the basis of the LED-output clock signal LEDCK and the field output request signal REQ to output the generated signal to the LED driver 70.

This allows the displayed imagery in the third frame to turn yellow in every field so that the yellow monochrome image is displayed, and the luminance thereof is about three times as compared with the luminance in the case of the second frame. The same is applied to the fourth frame. After the yellow monochrome image having the high luminance is displayed at two frames in this way, transition to the fifth frame occurs. A detailed description of the fifth frame is omitted, which is similar to the case of the fifth frame illustrated in FIG. 8.

In FIG. 11, even in a case where there is at least one frame having the LCD data R, G, and B none of which is “0”, transition from the fifth frame transitions to the sixth frame in which the color image is displayed by the normal field sequential driving occurs. However, the transition from the fifth frame to the sixth frame may occur in a case that four frames continue each of which has the LCD data R, G, and B none of which is “0”, for example. In this case, after three such frames continue, in a case where a frame at which the blue LCD data B is “0” is detected, transition may occur from the fifth frame to a frame at which the yellow monochrome image having the high luminance is displayed, such as the third frame.

Note that the number of frames at which blue LCD data B is “0”, the number of frames at which the monochrome image is continuously displayed, and the number of frames at which none of the LCD data R, G, and B is “0” are configured using the register circuit 25. Those configuration values stored in the register circuit 25 may be also changed on the PC.

The LCD data of “0” is not limited to the case of the blue LCD data B, and may be for the red LCD data R or green LCD data G. In this case, in the fourth frame and the fifth frame, all the displayed images may turn cyan so that a cyan monochrome image is displayed at a high luminance, or all the displayed images may turn magenta so that a magenta monochrome image is displayed at a high luminance. Such changes are made by rewriting the programs or configuration values for the output control circuit 20 using the register circuit 25.

### 3.3 Effects

According to the present embodiment, during the normal field sequential driving, the number of frames at which the blue LCD data B is “0” is counted, and in a case that the count value becomes the same value as the configuration value, the LCD timing controller 30 performs the frequency conversion on the frame constituted by three fields into the frame constituted by two fields to cause the red LED 85r and the green LED 85g to light up at the same time in each field. This allows all the displayed images in the respective fields to turn yellow so that the yellow monochrome image is displayed. In this case, since the red LED 85r and the green LED 85g light up at the same time throughout one frame, the luminance of the yellow monochrome image is three times as compared with the case that the red LED 85r and the green LED 85g sequentially light up on field-by-field.

### 3.4 Modification Example

In the above third embodiment, it is assumed that one frame is constituted by three fields. However, one frame may be constituted by four or more fields. Therefore, a case that one frame is constituted by four fields and a case that one frame is constituted by five fields are describe below.

### 3.4.1 First Modified Example

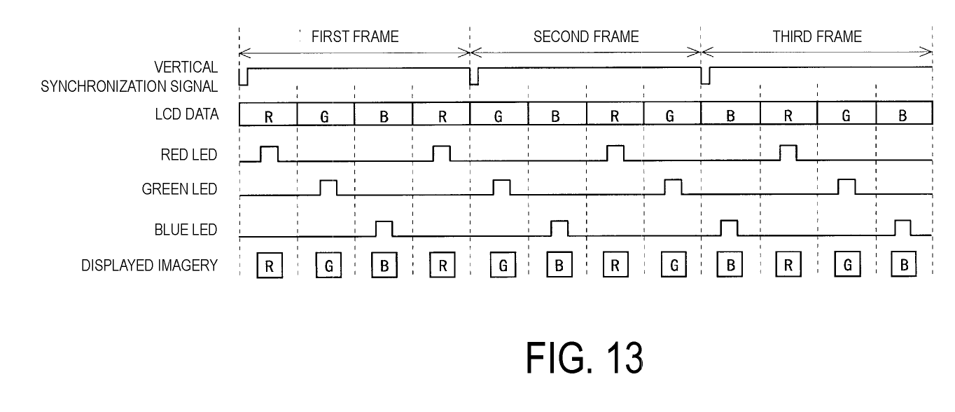

In a first modified example, one frame is constituted by four fields, and respective fields correspond to any of the red, green, and blue fields. FIG. 13 is a diagram illustrating a timing chart in the case that one frame is constituted by four fields to perform the normal field sequential driving. As illustrated in FIG. 13, the first frame is constituted by the red, green, blue, and red fields, and the second frame is constituted by the green, blue, red, and green fields. The third frame is constituted by the blue, red, green, and blue fields. This allows the red, green, and blue images to be cyclically displayed so that the viewer can view the color image constituted by red, green, and blue colors. In this case, an image of the same color is displayed in a first field and a last field in each frame.

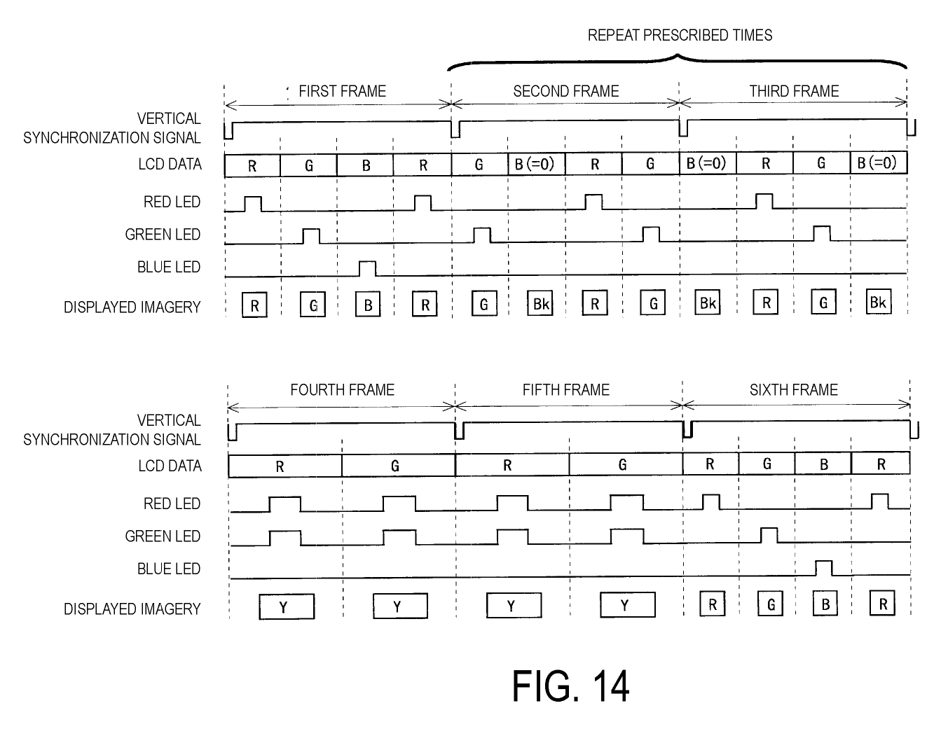

FIG. 14 is a diagram illustrating a timing chart in the first modified example of the above third embodiment where one frame is constituted by four fields. As illustrated in FIG. 14, in both the third fields as constituents of the second and third frames, the blue LCD data B is “0”. In this way, in a case that the blue LCD data B is “0” at two continuous frames, the frequency conversion is performed on the next fourth and fifth frames to constitute each of the fourth and fifth frame by two fields. The red LCD data R is read for the first field in the fourth frame and the green LCD data G is read for the second field to cause the red LED 85r and the green LED 85g to light up at the same time in both fields. Similarly, also in the fifth frame, the red LCD data R is read for the first field and the green LCD data G is read for the second field to cause the red LED 85r and the green LED 85g to light up at the same time in both fields. This allows all the displayed images in the respective fields in the fourth and fifth frames to turn yellow so that the yellow monochrome image having high luminance can be displayed. Note that in a field at which the blue LCD data B is “0” and none of the LEDs 85r, 85g, and 85b is made to light up, such as in the second field in the second frame, the displayed imagery is black (Bk) by making the backlight light and the ambient light not pass through the liquid crystal panel 81. However, the displayed imagery may be white (W) by making the backlight light and the ambient light pass through the liquid crystal panel 81.

In the sixth frame, entering into the normal field sequential driving is done in which the red, green and blue LEDs 85r, 85g, and 85b are sequentially made to light up so that the color image is displayed. In this way, also in the case that one frame is constituted by four fields, the yellow monochrome image can be displayed at a high luminance.

### 3.4.2 Second Modified Example

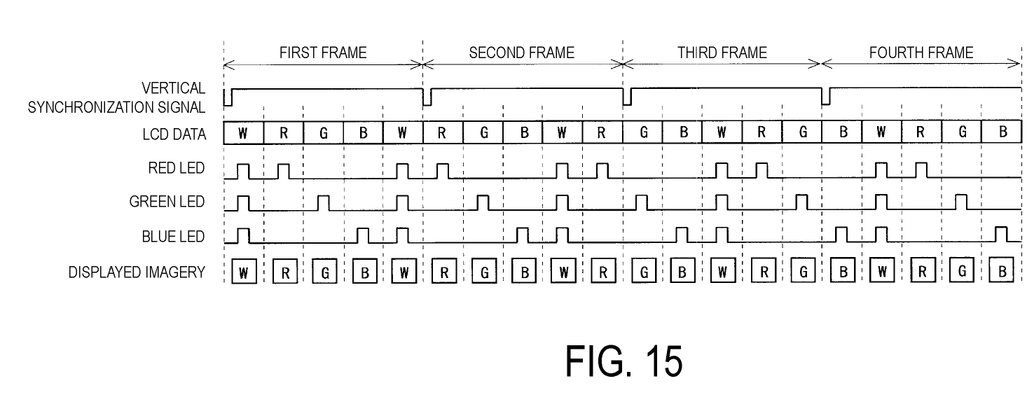

In a second modified example, one frame is constituted by five fields, and respective fields are any of the white, red, green, and blue fields. In FIG. 15, one frame is constituted by five fields, which include the red, green, and blue fields and further the white field added thereto. Adding the white field in this way can prevent color breakup which is likely to be problematic in the field sequential driving.

A description of the normal field sequential driving in a case that one frame is constituted by five fields is similar to the case described in the second modified example of the second embodiment illustrated in FIG. 15, and the description is omitted.

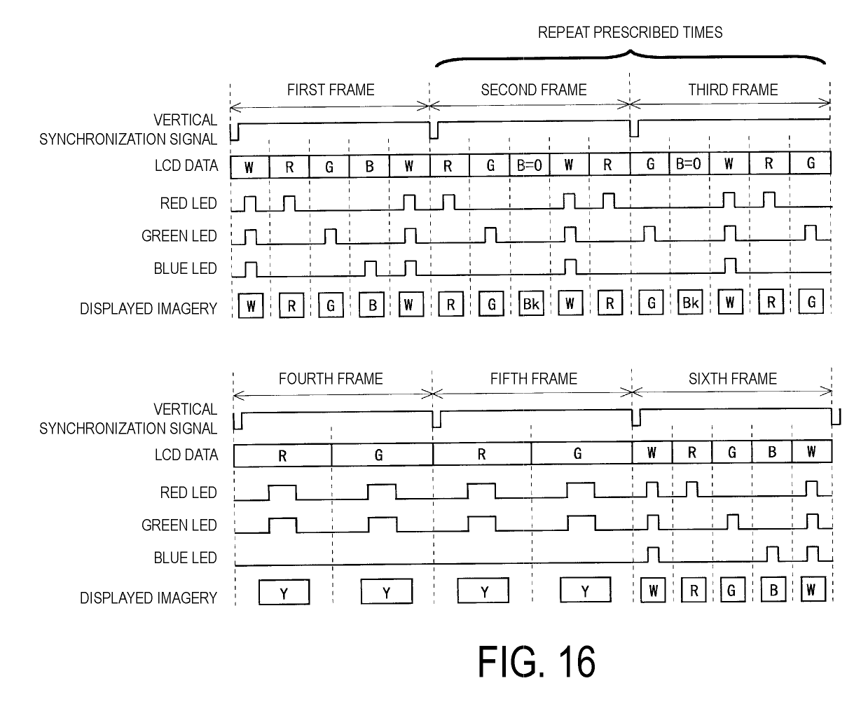

FIG. 16 is a diagram illustrating a timing chart in the second modified example of the above third embodiment where one frame is constituted by five fields. As illustrated in FIG. 16, any of the blue LCD data B included in the second and third frames is “0”. In this way, in a case where the blue LCD data B is “0” at two continuous frames, the frequency conversion is performed on the next fourth and fifth frames to constitute each of the fourth and fifth frame by two fields. The red LCD data R is read for the first field in the fourth frame and the green LCD data G is read for the second field to cause the red LED 85r and the green LED 85g to light up at the same time in both fields. Similarly, also in the fifth frame, the red LCD data R is read for the first field and the green LCD data G is read for the second field to cause the red LED 85r and the green LED 85g to light up at the same time in both fields. This allows all the displayed images in the respective fields in the fourth and fifth frames to turn yellow so that the yellow monochrome image having a high luminance can be displayed. Note that a description of the six frame is omitted because the description is similar to the case of the first modified example. This allows the yellow monochrome image to be displayed at a high luminance. Note that in a field where the blue LCD data B is “0” and none of the LEDs 85r, 85g, and 85b is made to light up, such as in the third field in the second frame, the displayed imagery is black (Bk) by making the backlight light and the ambient light not pass through the liquid crystal panel 81. On the other hand, in a field where all the LEDs 85r, 85g, and 85b are made to light up, the displayed imagery is white (W) by making the backlight light pass through the liquid crystal panel 81.

In all of the above modified examples, in a case where the blue LCD data B is “0” at two continuous frames, the yellow monochrome image is displayed at a high luminance. However, the present invention is not limited to this. The second image detection circuit 24 may count the number of frames at which the blue LCD data B is “0”, and in a case that the count value becomes a configuration value, the LCD timing controller 30 may perform the frequency conversion so that transition occur from the third frame to the fourth frame at which an image is displayed at a higher luminance than that in the third frame. The LCD data of “0” is not limited to the case of the blue LCD data B, and may be for the red LCD data R or green LCD data G. In this case, the monochrome image displayed in the fourth frame turns cyan or magenta. Such changes can be made by changing the configuration values for the output control circuit 20 using the register circuit 25.

### 4. Fourth Embodiment

### 4.1 Configuration and Operation of Liquid Crystal Display Device

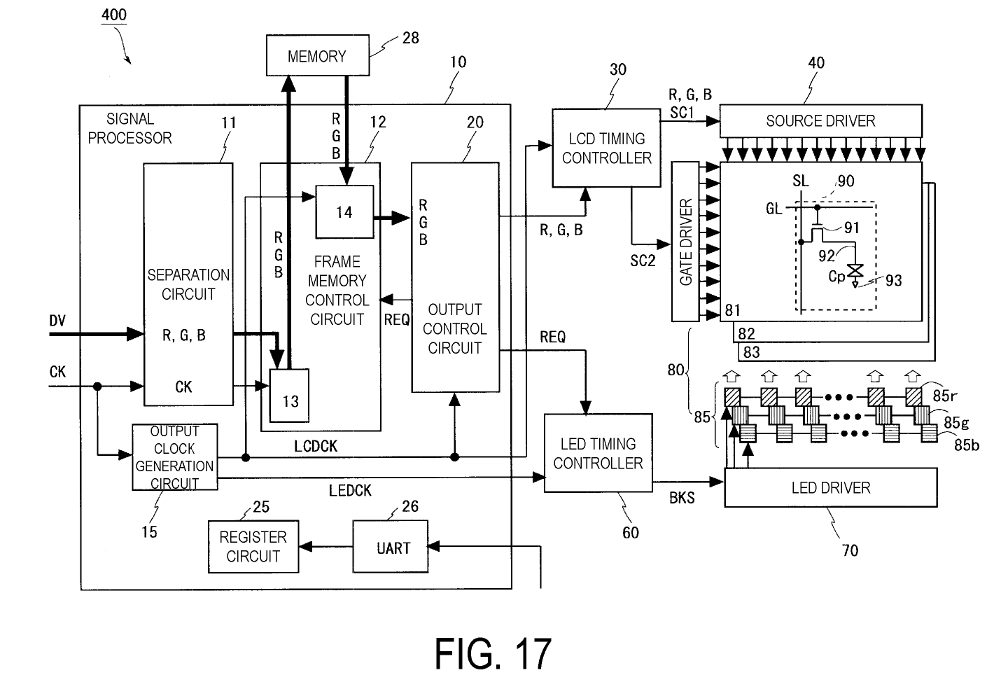

FIG. 17 is a block diagram illustrating a configuration of a liquid crystal display device 400 according to a fourth embodiment of the present invention. Although the backlight light source 85 in the liquid crystal display device 100 illustrated in FIG. 1 is described as a direct backlight, the backlight light source 85 in the liquid crystal display device 400 according to the present embodiment is an edge light as illustrated in FIG. 17 where the red, green and blue LEDs 85r, 85g, and 85b are attached to a light guide plate 83 at a lateral side thereof, but except for this point, has the same configuration as that of the liquid crystal display device 100 illustrated in FIG. 1, and a reflector, diffuser plate, and the like are not provided to the light guide plate 83 at the back face side thereof. Therefore, the components in the liquid crystal display device 400 which are the same as the components in the liquid crystal display device 100 are denoted by the same reference signs, and the descriptions thereof are omitted.

The light guide plate 83 including an end portion to which the respective color LEDs 85r, 85g, and 85b are attached is used as the backlight light source 85, so that the lights emitted from the LEDs 85r, 85g, and 85b totally are reflected by a surface of the light guide plate 83 while propagating through the light guide plate 83, and the light output from the light guide plate 83 toward the front face side illuminates the liquid crystal panel 81 as a backlight light from the back face side. This makes the light from the light guide plate 83 reach the front face side, which allows the viewer to view an image displayed on the liquid crystal panel 81. Moreover, since the light guide plate 83 outputs the light from its entire back face, the light from the light guide plate 83 also reaches the back face side in a field where, for example, the red LED 85r lights up, which allows the viewer to view the red light output from the entire back face of the light guide plate 83.

Note that in a case that all the LEDs 85r, 85g, and 85b of the backlight light source 85 do not emit light, the ambient light incident on the liquid crystal panel 81 from the front face side passes through the liquid crystal panel 81, and is reflected by the diffuser plate 82 disposed on a back face of the panel 81 toward the front face side to illuminate the liquid crystal panel 81. In the display region in the liquid crystal panel 81, an area through which the ambient light reflected by the diffuser plate 82 passes is displayed in white color, meanwhile other area through which the ambient light cannot pass depending on the orientation of the liquid crystal molecules is displayed in black color. This allows the viewer on the front face side to view the black character or image on a white background.

### 4.2 Timing chart

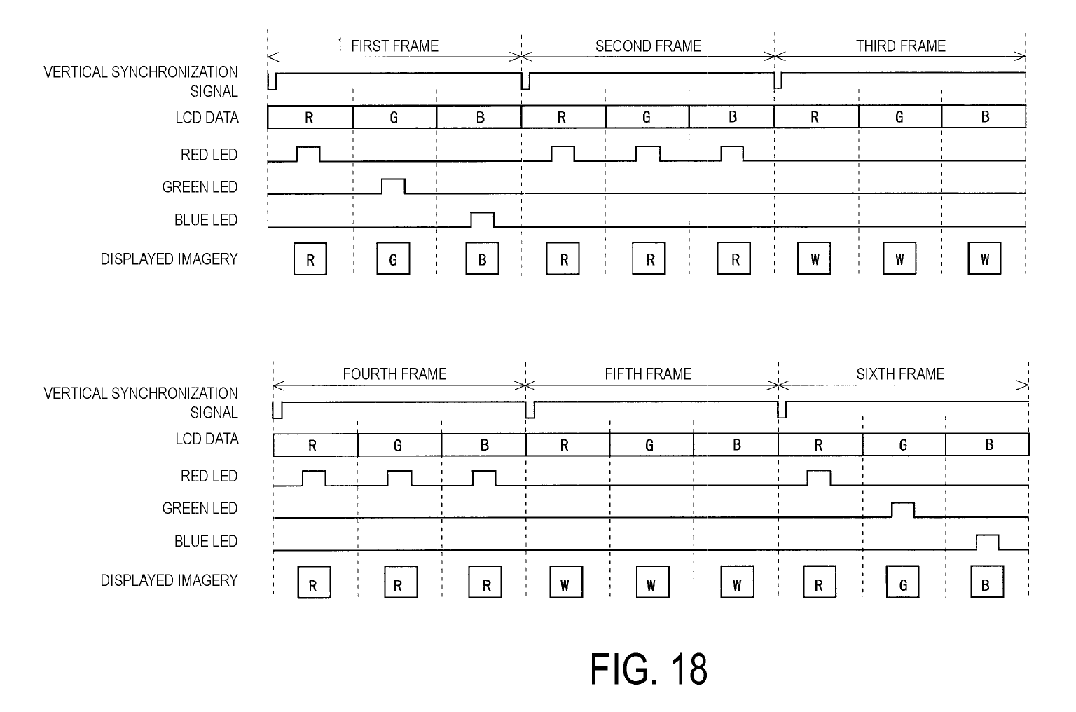

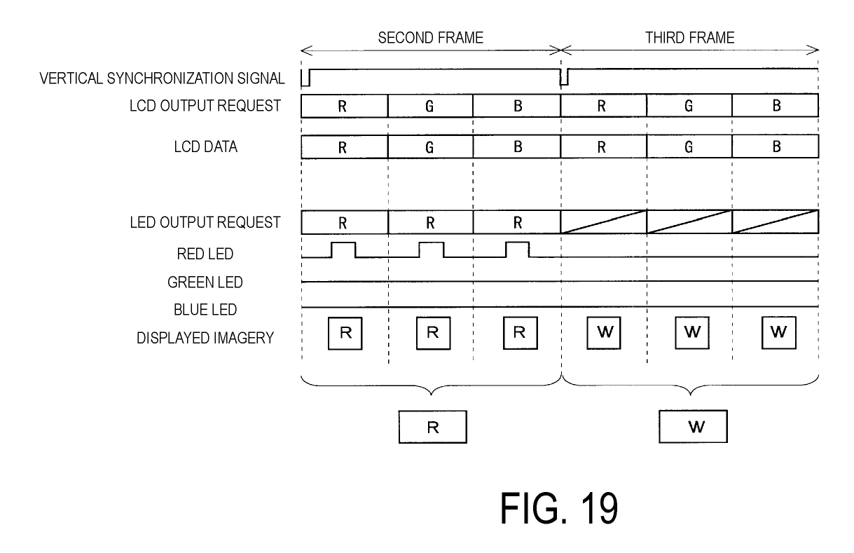

FIG. 18 is a diagram illustrating a timing chart for displaying an image by the field sequential driving in the liquid crystal display device 400 according to the present embodiment, and FIG. 19 is a diagram illustrating a timing chart which illustrates in more detail second and third frames illustrated in the timing chart in FIG. 18.

FIG. 18 illustrate the field sequential driving in which the image data DV at 60 Hz is separated into the respective red, green, and blue LCD data R, G, and B to sequentially display red, green, and blue images at 180 Hz, similar to the case illustrated in FIG. 4. In the first and sixth frames, the red LED 85r is made to light up in a case that the red LCD data R is read, the green LED 85g is made to light up in a case that the green LCD data G is read, and the blue LED 85b is made to light up in a case that the blue LCD data B is read, similar to the case of the first frame illustrated in FIG. 4. Therefore, the red, green, and blue displayed images are sequentially displayed for each field, which allows the viewer to view the color image constituted by red, green, and blue colors.

Next, the second frame is described. As illustrated in FIG. 18 and FIG. 19, in the second frame, the respective red, green, and blue LCD data R, G, and B are sequentially read for each field, but the red LED 85r is only made to light up in each field. This allows the displayed imagery in the second frame to turn red in every field so that the viewer can view the red monochrome image at a high luminance. The luminance of the red monochrome image in this case is three times the luminance in the normal field sequential driving. At this time, the red light is outputted from the light guide plate 83 not only toward the front face side as the backlight but also toward the back face side. This allows the viewer on the back face side of the liquid crystal display device 400 to view the light guide plate 83 whose entire back face outputs red light.

As illustrated in FIG. 18 and FIG. 19, in the third frame, the respective red, green, and blue LCD data R, G, and B are read from the memory 28 for each field so that the data voltage depending on the respective LCD data is applied to each data signal tine SL in the liquid crystal panel 81. However, none of the LEDs 85r, 85g, and 85b of the backlight light source 85 is not made to light up. For this reason, the ambient light incident on the liquid crystal panel 81 from the front face side of the liquid crystal display device 400 is reflected by the diffuser plate 82 to illuminate the liquid crystal panel 81. This allows the ambient light to pass through the liquid crystal panel 81 so that the displayed imagery in each field turns white. At this time, in a case that the orientation of the liquid crystal molecules depending on the applied data voltage indicates non-transmission of the ambient light, the ambient light cannot pass through the liquid crystal panel 81, and thus, is displayed in black color. This causes the viewer to view the image or character displayed in black color on the white background.

On the other hand, the lights from the LEDs 85r, 85g, and 85b are not emitted also on the back face side of the light guide plate 83. This allows the viewer on the back face side of the liquid crystal display device 400 to view the ambient light incident on the liquid crystal panel 81 via the light guide plate 83. As a result, the viewer on the back face side views on the white background an image or character of which left and right are reversed from the black image or character viewed by the viewer on the front face side.

Descriptions of the fourth frame and the fifth frame are omitted because the descriptions are the same as those of the above second frame and third frame, respectively. In FIG. 18, the backlight light source 85 lights up and goes out only two times. However, in a case that the backlight light source 85 lights up and goes out many times, the image and character can be displayed to blink. This causes the displayed image to further attract the viewer's attention.

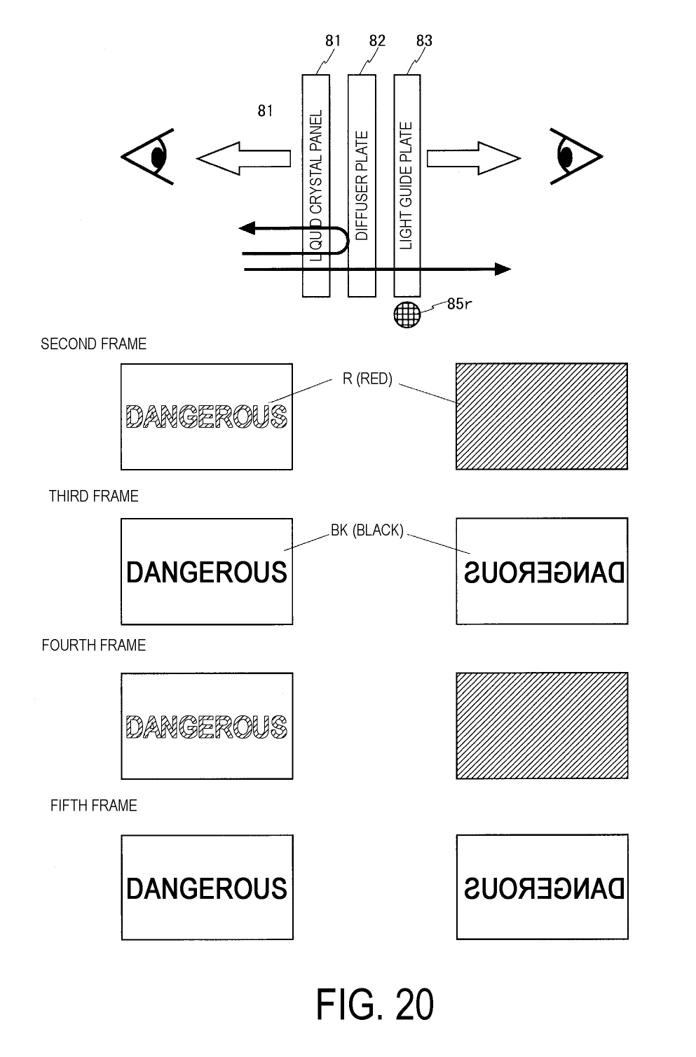

FIG. 20 is a diagram illustrating displays of four frames from the second frame to the fifth frame illustrated in FIG. 18. The displays can be viewed by the viewer on the front face side and viewed by the viewer on the back face side and notifies the viewers of that it is “dangerous”.

While an image of the content is displayed, in a case where a need arises to notify the viewers of “dangerous” based on an earthquake early warning, for example, simple and conspicuous displaying of the dangerous may be more effective. Therefore, the red characters of “dangerous” are displayed at a high luminance in a case that the backlight light source 85 is made to light up as in the second and fourth frames, and the black characters of “dangerous” are displayed in a case that the light of the backlight light source 85 is not made to light up as in the third and fifth frames. In this way, by blinking the backlight tight source 85, the characters of “dangerous” represented in red color and the characters of “dangerous” represented in black color can be alternately displayed on the front face side of the liquid crystal display device 400. Further, the red LED 85r is made to tight up in three fields constituting one frame so that the red characters are displayed at the luminance three times the case of the normal field sequential driving. This allows the viewer on the front face side of the liquid crystal display device 400 to more easily recognize that it is “dangerous”.

Since the liquid crystal display device 400 does not include a reflector or the like on the back face side of the light guide plate 83, the light output from the tight guide plate 83 toward the back face side causes alternate display of a state where the entire back face of the light guide plate 83 outputs red light and the characters of which left and right are reversed from the black characters “dangerous”. This also allows the viewer on the back face side to recognize that it is “dangerous”.

### 4.3 Effects

According to the present embodiment, the liquid crystal display device 400 can exert effects the same as or similar to the case of the above first embodiment. Moreover, a duration at which the backlight light source 85 does not light up is provided to increase a luminance difference from that of a duration at which the backlight light source 85 lights up, which allows the viewer to more easily view the monochrome image.

Also on the back face side of the liquid crystal display device 400, it is repeated that the entire face of the light guide plate 83 is colored in a same color as that of the monochrome image or the characters or image of which left and right are reversed is displayed in black-and-white color, which allows also the viewer on the back face side to easily view the displayed characters or image.

### 5. Others

The above embodiments describe the cases that the present invention is applied to the liquid crystal display device. However, the present invention is not limited to the liquid crystal display device, and can be applied to other display devices such as an organic electro-luminescence (EL) display device. In the case that the present invention is applied to other display device than the liquid crystal display device also, the same or similar effect can be obtained as in the case of applying to the liquid crystal display device.

In the above embodiments, it is assumed that the various programs or configuration values for controlling the operations of the circuits in the signal processor 10 are given from the register circuit 25 connected with the external PC via the UART 26, but may be given directly from the outside.

### INDUSTRIAL APPLICABILITY

The present invention is applied to a display device configured to display an image by the field sequential driving, such as an active matrix type liquid crystal display device.

### REFERENCE SIGNS LIST

10 Signal processor

11 Separation circuit

12 Frame memory control circuit

13 Write circuit

14 Read circuit

15 Output clock generation circuit

20 Output control circuit

21 Image detection circuit

23 First image detection circuit

24 Second image detection circuit

25 Register circuit

26 UART

30 LCD timing control circuit (image timing control unit)

40 Source driver (drive circuit)

50 Gate driver (drive circuit)

60 LED timing control circuit (light source timing control unit)

70 LED driver

80 Display unit

81 Liquid crystal panel (display panel)

82 Diffuser plate

83 Light guide plate

85 Backlight light source

85r, 85g, 85b Red, green, or blue LED (light emitting element)

90 Pixel forming section

100, 200, 300, 400 Liquid crystal display device (display device)

R, G, B Red, green, or blue LCD data (color image component)

DV Image data (input image data)

SL Data signal line

GL Scanning signal line

1. A display device configured to separate one frame constituted by a plurality of fields into the plurality of fields and display each of images different in color for each of the plurality of fields to display a color image, the display device comprising:
a display panel including a plurality of pixel forming sections arranged in a matrix;
a drive circuit configured to drive the plurality of pixel forming sections;
a backlight light source disposed on a back face side of the display panel, including a plurality of light emitting elements configured to emit lights different in color for each of the plurality of fields, and configured to illuminate the display panel with the lights emitted from the plurality of light emitting elements as a backlight;
a light source timing control unit configured to control colors of the lights emitted from the plurality of light emitting elements and timings at which the plurality of light emitting elements are made to emit the lights;
an image timing control unit configured to output a plurality of color image components representing images different in color included in input image data and timings at which the plurality of color image components are outputted to the drive circuit; and
a signal processor configured to separate the input image data into the plurality of color image components representing the images different in color, output the plurality of color image components to the image timing control unit for each of the plurality of fields, select a light emitting element of the plurality of light emitting elements, the light emitting element being configured to emit a light of a color required for displaying each of the plurality of color image components, and output a light emitting element control signal configured to control a light emitting timing for the light emitting element to the light source timing control unit,
wherein the signal processor outputs the light emitting element control signal configured to cause light emitting elements of the plurality of light emitting elements to emit lights in all the plurality of fields in which the plurality of color image components different in color are outputted in the one frame, the light emitting elements being configured to emit a same color light.

2. The display device according to claim 1,
wherein the one frame is constituted by three fields,
the plurality of color image components include a red image component representing red image data, a green image component representing green image data, and a blue image component representing blue image data,
the backlight light source includes a red light emitting element configured to emit a red light, a green light emitting element configured to emit a green light, and a blue light emitting element configured to emit a blue light, and
the signal processor is configured to output, to the light source timing control unit, a light emitting element control signal configured to cause any of the red light emitting element, the green light emitting element, and the blue light emitting element to emit a light for each of the plurality of fields in which the signal processor separates the input image data of the one frame into the red image component, the green image component, and the blue image component and outputs the red image component, the green image component and the blue image component to the image timing control unit, and cause a same color image to be displayed in the three fields.

3. The display device according to claim 2,
wherein the signal processor is configured to output, to the light source timing control unit, a light emitting element control signal configured to cause, in a first field in a frame immediately before a frame at which an image of a same color is displayed in the three fields, a light emitting element of a color identical to the same color in the three fields to emit a light, and cause, in second and third fields, none of the plurality of light emitting elements to emit the light.

4. The display device according to claim 3, further comprising:
a diffuser plate disposed between the display panel and the backlight light source, and configured to uniformly diffuse a backlight emitted from the backlight tight source and illuminate the display panel,
wherein an ambient light incident on a front face side of the display panel is reflected by the diffuser plate and illuminates the display panel in the second and third fields in the frame immediately before.

5. The display device according to claim 1,
wherein the one frame is constituted by three fields,
the plurality of color image components include a red image component representing red image data, a green image component representing green image data, and a blue image component representing blue image data,
the backlight light source includes a red light emitting element configured to emit a red light, a green light emitting element configured to emit a green light, and a blue light emitting element configured to emit a blue light, and
the signal processor is configured to output, in a case that the input image data including a prescribed number of continuous frames not including a color image component of a specific color are detected, the red image component, the green image component, and the blue image component to the image timing control unit for each of the plurality of fields, output, to the light source timing control unit, a light emitting element control signal configured to cause two light emitting elements of the red light emitting element, the green light emitting element, and the blue light emitting element other than a light emitting element of a color corresponding to the color image component of the specific color to simultaneously emit lights for each of the plurality of fields, and cause a same color image to be displayed in the three fields.

6. The display device according to claim 1,
wherein the one frame is constituted by three fields,
the plurality of color image components include a red image component representing red image data, a green image component representing green image data, and a blue image component representing blue image data,
the backlight light source includes a red light emitting element configured to emit a red light, a green light emitting element configured to emit a green light, and a blue light emitting element configured to emit a blue light,
the signal processor is configured to output, in a case that the input image data including a prescribed number of continuous frames not including a color image component of a specific color are detected, two color image components of the red image component, the green image component, and the blue image component other than the color image component of the specific color to the image timing control unit for each of the plurality of fields, and output, to the light source timing control unit, a light emitting element control signal configured to cause two light emitting elements of the red light emitting element, the green light emitting element, and the blue light emitting element other than a light emitting element of a color corresponding to the color image component of the specific color to simultaneously emit lights in the three fields,
the image timing control unit is configured to convert the three fields into two fields in which images corresponding to the two color image components are displayed, and
the light source timing control unit is configured to cause light emitting elements of the plurality of light emitting elements of colors corresponding to the two color image components to simultaneously light up in each of the two fields and cause a same color image to be displayed in the two fields.

7. The display device according to claim 5 or 6,
wherein the signal processor is configured to output, in a case that the input image data including a prescribed number of continuous frames constituted by all the color image components including the specific color are detected, the red image component, the green image component, and the blue image component to the image timing control unit for each of the plurality of fields, and output a light emitting element control signal configured to cause the red light emitting element, the green light emitting element, and the blue light emitting element to sequentially emit lights for each of the plurality of fields to the light source timing control unit.

8. The display device according to claim 6,
wherein the one frame is constituted by at least four fields, and
the signal processor is configured to output, in a case that the input image data including a prescribed number of continuous frames not including the color image component of the specific color are detected, two color image components of the red image component, the green image component, and the blue image component other than the color image component of the specific color to the image timing control unit for each of the plurality of fields, and output, to the light source timing control unit, a light emitting element control signal configured to cause two light emitting elements of the red light emitting element, the green light emitting element, and the blue light emitting element other than the light emitting element of a color corresponding to the color image component of the specific color to simultaneously emit lights for each of the plurality of fields.

9. The display device according to claim 7,
wherein the plurality of color image components further include a white image component representing white image data, and
the signal processor is configured to output, in a case that the input image data including a prescribed number of continuous frames not including the color image component of the specific color are detected, two color image components of the white image component, the red image component, the green image component, and the blue image component other than the white image component and the color image component of the specific color to the image timing control unit for each of the plurality of fields, and output, to the light source timing control unit, a light emitting element control signal configured to cause the two light emitting elements of the red light emitting element, the green light emitting element, and the blue light emitting element other than the light emitting element of a color corresponding to the color image component of the specific color to simultaneously emit lights for each of the plurality of fields.

10. The display device according to claim 1,
wherein the one frame is constituted by three fields,
the color image components include a red image component representing red image data, a green image component representing green image data, and a blue image component representing blue image data,
the backlight light source includes a light guide plate including a red light emitting element configured to emit a red light, a green light emitting element configured to emit a green light, and a blue light emitting element configured to emit a blue light attached to an end portion of the light guide plate,
the display device further comprising a diffuser plate disposed between the display panel and the light guide plate, and configured to uniformly diffuse a backlight output from the light guide plate and illuminate the display panel,
the signal processor is configured to output the tight emitting element control signal to the tight source timing control unit with alternately repeating frames, one of the fames being a frame at which the red image component, the green image component, and the blue image component are sequentially outputted to the image timing control unit for each of the three fields and any of the red light emitting element, the green light emitting element, and the blue light emitting element is made to emit a light in the three fields, the other of the frames being a frame at which the red image component, the green image component, and the blue image component are sequentially outputted to the image timing control unit in the three fields and none of the red light emitting element, the green light emitting element, and the blue light emitting element is made to emit a light in any of the three fields,
in a frame at which any of the red light emitting element, the green light emitting element, and the blue light emitting element is made to emit a light, the light emitted by any of the red light emitting element, the green light emitting element, and the blue light emitting element illuminates the display panel, passes through the light guide plate, and reaches the back face side, and
in a frame at which none of the red light emitting element, the green light emitting element, and the blue light emitting element is made to emit a light, an ambient light incident on a front face side of the display panel is reflected by the diffuser plate, illuminates the display panel, passes through the diffuser plate and the light guide plate, and reaches the back face side.

11. A method for driving a display device configured to separate one frame constituted by a plurality of fields into the plurality of fields and display each of images different in color for each of the plurality of fields to display a color image, the method comprising:
separating input image data into a plurality of color image components representing the images different in color;
outputting the plurality of color image components to an image timing control unit for each of the plurality of fields;
selecting a light emitting element configured to emit a light of a color required for displaying each of the plurality of color image components and outputting a light emitting element control signal configured to control a light emitting timing for the light emitting element to a light source timing control unit; and
causing a plurality of the light emitting elements configured to emit a same color light to emit lights in all the plurality of fields in the one frame at which the plurality of color image components representing the images in different color are outputted.
